(19) United States
(12) Patent Application Publication
(10) Pub. No.: US 2026/0349102 A1
(43) Pub. Date: Nov. 5, 2026

(54) COMMUNICATION CONFIGURATION TO FACILITATE SENSING SIGNAL RECEPTION

(71) Applicant: QUALCOMM Incorporated, San Diego, CA (US)

(72) Inventors: Min HUANG, Beijing (CN); Mingxi YIN, Beijing (CN); Hao XU, Beijing (CN)

(21) Appl. No.: 19/487,444

(22) PCT Filed: Aug. 3, 2023
(86) PCT No.: PCT/CN2023/110929

§ 371 Date: Nov. 24, 2025

(51) Int. Cl. G01S 13/06; G01S 7/00; H04L 27/26

(52) U.S. Cl. CPC G01S 13/06; G01S 7/006; H04L 27/2607

(57) ABSTRACT

A wireless device may receive a configuration message. The configuration message may include a first indicator of a searching time scope associated with a sensing signal or a second indicator of a sensing-associated sensing signal (SA-SS) gap associated with a SA-SS and the sensing signal. The wireless device may receive a reflection of the sensing signal off of a target object within a sensing area. The wireless device may measure the received reflection of the sensing signal based on at least one of the searching time scope or the SA-SS gap. The wireless device may calculate a location of the target object based on the measured reflection of the sensing signal. The wireless device may output a third indicator of the calculated location of the target object.

### TECHNICAL FIELD

The present disclosure relates generally to communication systems, and more particularly, to a wireless sensing system.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus may include a user equipment (UE) or a network node. The apparatus may receive a configuration message. The configuration message may include a first indicator of a searching time scope associated with a sensing signal or a second indicator of a sensing-associated sensing signal (SA-SS) gap associated with a SA-SS and the sensing signal. The apparatus may receive a reflection of the sensing signal off of a target object within a sensing area. The apparatus may measure the received reflection of the sensing signal based on at least one of the searching time scope or the SA-SS gap. The apparatus may calculate a location of the target object based on the measured reflection of the sensing signal. The apparatus may output a third indicator of the calculated location of the target object. The apparatus may output the third indicator by transmitting a report message including a third indicator of the calculated location of the target object or by storing the third indicator of the calculated location of the target object.

In an aspect of the disclosure, a method, a computer-readable medium, and an apparatus are provided. The apparatus may include a user equipment (UE) or a network node. The apparatus may transmit a configuration message. The configuration message may include a first indicator of a searching time scope associated with a sensing signal and a sensing area or may include a second indicator of a sensing-associated sensing signal (SA-SS) gap associated with a SA-SS and the sensing signal. The apparatus may transmit the sensing signal in the sensing area. The apparatus may receive a report message. The report message may include a third indicator of a location of a target object within the sensing area calculated based on the configuration message.

To the accomplishment of the foregoing and related ends, the one or more aspects may include the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of downlink (DL) channels within a subframe, in accordance with various aspects of the present disclosure.

FIG. 2C is a diagram illustrating an example of a second frame, in accordance with various aspects of the present disclosure.

FIG. 2D is a diagram illustrating an example of uplink (UL) channels within a subframe, in accordance with various aspects of the present disclosure.

FIG. 3 is a diagram illustrating an example of a base station and user equipment (UE) in an access network.

FIG. 4 is a diagram illustrating an example of sensing based on measurements of reflections of sensing signals.

FIG. 5A is a diagram illustrating an example of a first wireless device transmitting a communication beam at a second wireless device and a sensing beam at a target object at a first distance from the second wireless device.

FIG. 5B is a diagram illustrating an example of the first wireless device in FIG. 5A transmitting a communication beam at the second wireless device in FIG. 5A and a sensing beam at a target object at a second distance from the second wireless device.

FIG. 6A is a diagram illustrating an example of sensing and communication signals that are received at a receiver with different relative delays.

FIG. 6B is a diagram illustrating an example of a wireless device calculating a minimum and a maximum sensing distance based on the dimensions of a sensing area.

FIG. 7 is a diagram illustrating an example of sensing and communication signals that are received at a receiver with different relative delays.

FIG. 8 is a communication flow diagram illustrating an example of a first wireless device transmitting a communication beam at a second wireless device and a sensing beam at a target object for the second wireless device to perform sensing.

FIG. 9A is a diagram illustrating an example of a communication beam and sensing beam transmitted simultaneously from a transmitting device.

FIG. 9B is a diagram illustrating an example of the resource elements (REs) of the communication beam and the sensing beam of FIG. 9A.

FIG. 9C is a diagram illustrating an example of a communication beam and a sensing beam received simultaneously at a receiver device.

FIG. 10 is a diagram illustrating an example of a plurality of sliding windows used to determine when a sensing-associated sensing signal (SA-SS) is received by a receiver device.

FIG. 11 is a communication flow diagram illustrating an example of a first wireless device transmitting a communication beam at a second wireless device and a sensing beam at a target object for the second wireless device to perform sensing.

FIG. 12 is a flowchart of a method of wireless communication.

FIG. 13 is a flowchart of a method of wireless communication.

FIG. 14 is a diagram illustrating an example of a hardware implementation for an example apparatus and/or network entity.

FIG. 15 is a diagram illustrating an example of a hardware implementation for an example network entity.

FIG. 16 is a diagram illustrating an example of a hardware implementation for an example network entity.

### DETAILED DESCRIPTION

The following description is directed to examples for the purposes of describing innovative aspects of this disclosure. However, a person having ordinary skill in the art may recognize that the teachings herein may be applied in a multitude of ways. Some or all of the described examples may be implemented in any device, system or network that is capable of transmitting and receiving radio frequency (RF) signals according to one or more of the Institute of Electrical and Electronics Engineers (IEEE) 802.11 standards, the IEEE 802.15 standards, the Bluetooth® standards as defined by the Bluetooth Special Interest Group (SIG), or the Long Term Evolution (LTE), 3G, 4G or 5G (New Radio (NR)) standards promulgated by the 3rd Generation Partnership Project (3GPP), among others. The described examples may be implemented in any device, system or network that is capable of transmitting and receiving RF signals according to one or more of the following technologies or techniques: code division multiple access (CDMA), time division multiple access (TDMA), frequency division multiple access (FDMA), orthogonal FDMA (OFDMA), single-carrier FDMA (SC-FDMA), spatial division multiple access (SDMA), rate-splitting multiple access (RSMA), multi-user shared access (MUSA), single-user (SU) multiple-input multiple-output (MIMO) and multi-user (MU)-MIMO. The described examples also may be implemented using other wireless communication protocols or RF signals suitable for use in one or more of a wireless personal area network (WPAN), a wireless local area network (WLAN), a wireless wide area network (WWAN), a wireless metropolitan area network (WMAN), or an internet of things (IoT) network.

Various aspects relate generally to wireless sensing and communication systems. Some aspects more specifically relate to devices that perform both wireless sensing and wireless communication simultaneously based on the same bandwidth and the same duration.

In integrated sensing and communication (ISAC) systems, wireless devices may perform both communication and sensing with one another. For example, a first wireless device may transmit a communication signal to a second wireless device, and the first wireless device may perform bistatic sensing with the second wireless device. If the distance from the first wireless device to the target object and back to the second wireless device is much larger than the distance from the first wireless device to the second wireless device, the propagation delay in the sensing path may be larger than the length of the cyclic prefix of the orthogonal frequency division multiplexing (OFDM) symbol. This may result in the sampling window for sensing falling partially or completely outside the sampling window for communication. As a result, the wireless device receiving the reflection of the sensing signal may not properly receive and measure the reflection of the sensing signal. Searching for a sensing signal outside of the sampling window for communication may waste resources. In some aspects, a wireless device transmitting the communication and sensing signals may indicate a sensing signal searching time scope to the wireless device receiving the communication and sensing signals. The searching time scope may be determined based on a distance between the sensing area and the transmitting/receiving sensing devices and based on the communication propagation delay. The wireless device receiving the communication and sensing signals may use the bounds of the time scope to search for the sensing signal. In some aspects, a first wireless device transmitting communication and sensing signals may transmit a sensing-associated synchronization signal (SA-SS) before transmitting the sensing signal. The first wireless device may transmit the configuration of the SA-SS. The second wireless device receiving the communication and sensing signals may report the processing latency of detecting the SA-SS based on SA-SS configuration. The first wireless device may configure the gap between SA-SS and sensing RS based on the processing latency. The first wireless device may transmit the SA-SS in front of the sensing reference signal (RS) based on the configured gap (i.e., based on the gap between the SA-SS and sensing signal. The second wireless device may determine the sampling window for sensing.

In some examples, a wireless device may receive a configuration message. The configuration message may include a first indicator of a searching time scope associated with a sensing signal or a second indicator of a sensing-associated sensing signal (SA-SS) gap associated with a SA-SS and the sensing signal. The wireless device may receive a reflection of the sensing signal off of a target object within a sensing area. The wireless device may measure the received reflection of the sensing signal based on at least one of the searching time scope or the SA-SS gap. The wireless device may calculate a location of the target object based on the measured reflection of the sensing signal. In some aspects, the wireless device may output a third indicator of the calculated location of the target object. The wireless device may output the third indicator by transmitting a report message that may include a third indicator of the calculated location of the target object. The wireless device may output the third indicator by storing the third indicator of the calculated location of the target object, for example on a memory or on a cache. The wireless device may receive a communication message while receiving the reflection of the sensing signal. The wireless device may process the communication message.

In some examples, a wireless device may transmit a configuration message. The configuration message may include a first indicator of a searching time scope associated with a sensing signal and a sensing area or may include a second indicator of a SA-SS gap associated with a SA-SS and the sensing signal. The wireless device may transmit the sensing signal in the sensing area. The wireless device may transmit a communication message at a second wireless device while transmitting the sensing signal in the sensing area.

In sensing scenarios, for example network nodes (e.g., next generation base station (gNB)) in bistatic integrated communications and sensing (ICAS) scenarios, when the reflective path for a sensing signal (e.g., a gNB->target object->UE) is much larger than the distance between wireless devices (e.g., the gNB->UE), the propagation delay in the sensing path may be larger than the length of the cyclic prefix (CP). Thus, the wireless device receiving both the communication symbol and the sensing symbol may not properly receive the sensing signal (or may receive a partial sensing signal) if the wireless device monitors a time window limited to the time window in which the wireless device receive the communications signal (i.e., n the sampling window for communication). The receiving wireless device may search for the sensing symbol outside the sampling window for communication, however such a search may result in power/resource wastage. In one aspect, a wireless device (e.g., a gNB) transmitting the signal used for both communications and sensing may indicate a sensing signal searching time scope to the wireless device receiving both the communications and sensing signals, which may be determined based on distances between the sensing area and both wireless devices and based on the communication propagation delay. The receiving wireless device may use the bounds of the time scope to search for the sensing signal. In one aspect, an SA-SS may be used whose configuration is indicated by the transmitting wireless device to the receiving wireless device. The receiving wireless device may report the processing latency of detecting SA-SS based on SA-SS configuration. The transmitting wireless device may accordingly configure the gap between SA-SS and sensing RS. The transmitting wireless device may transmit an SA-SS in front of sensing RS based on the configured gap. Based on the gap between SA-SS and sensing signal, the receiving wireless device may determine the sampling window for sensing.

Particular aspects of the subject matter described in this disclosure can be implemented to realize one or more of the following potential advantages. In some examples, by transmitting a searching time scope for the sensing signal, the described techniques can be used to minimize the resources used to search for the sensing signal by allowing the wireless device receiving the communication and sensing signals to monitor an optimized time period for the sensing signals. In some examples, by transmitting a SA-SS before transmitting a sensing signal with a configured gap between the SA-SS and the sensing signal, the wireless device receiving the communication and sensing signals may reduce the resources used by monitoring a smaller bandwidth (BW) used by the SA-SS, calculating when the sensing signal will arrive, and then monitoring a larger BW using the calculated time. Such aspects improve spectrum efficiency. By indicating a searching time scope for a sensing signal and/or by transmitting a SA-SS prior to transmitting a sensing signal, such aspects may reduce the processing complexity and latency of the sensing receiver. Moreover, such aspects may reduce power consumption in the sensing receiver.

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. When multiple processors are implemented, the multiple processors may perform the functions individually or in combination. Examples of processors include microprocessors, microcontrollers, graphics processing units (GPUS), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can include a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer. While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals may include a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmission reception point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

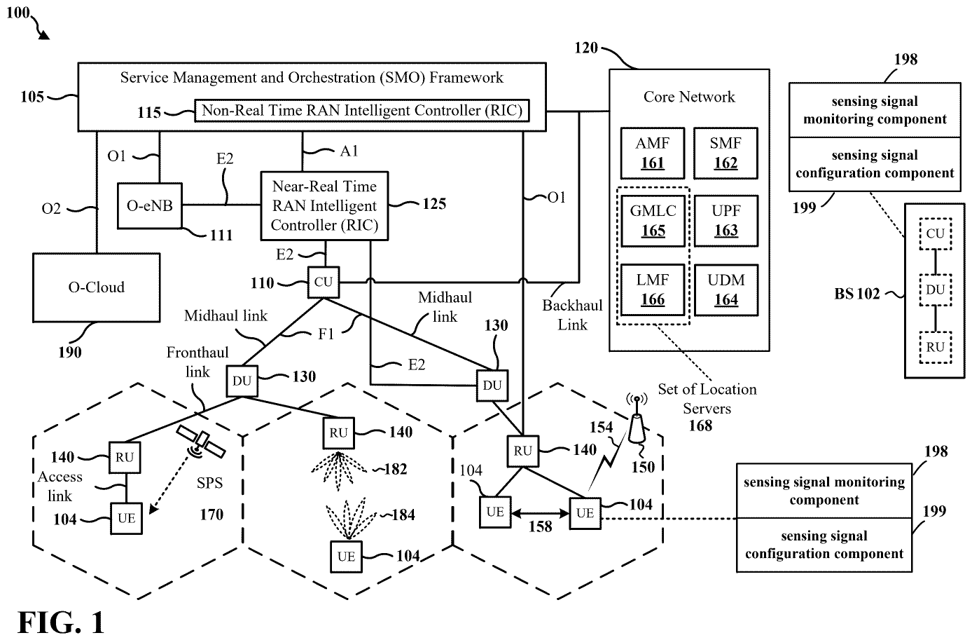

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140.

Each of the units, i.e., the CUS 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit-User Plane (CU-UP)), control plane functionality (i.e., Central Unit-Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as appropriate, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-eNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via 01) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base station 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base station 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth™ (Bluetooth is a trademark of the Bluetooth Special Interest Group (SIG)), Wi-Fi™ (Wi-Fi is a trademark of the Wi-Fi Alliance) based on the Institute of Electrical and Electronics Engineers (IEEE) 802.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FR1 (410 MHz-7.125 GHZ) and FR2 (24.25 GHz-52.6 GHZ). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHz-71 GHz), FR4 (71 GHz-114.25 GHz), and FR5 (114.25 GHZ-300 GHz). Each of these higher frequency bands falls within the EHF band.

With the above aspects in mind, unless specifically stated otherwise, the term “sub-6 GHz” or the like if used herein may broadly represent frequencies that may be less than 6 GHZ, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, eNB, an access point, a base transceiver station, a radio base station, a radio transceiver, a transceiver function, a basic service set (BSS), an extended service set (ESS), a TRP, network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the base station 102 serving the UE 104. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in certain aspects, the UE 104 and/or the base station 102 may have a sensing signal monitoring component 198 that may be configured to receive a configuration message. The configuration message may include a first indicator of a searching time scope associated with a sensing signal or a second indicator of a SA-SS gap associated with a SA-SS and the sensing signal. The sensing signal monitoring component 198 may be configured to receive a reflection of the sensing signal off of a target object within a sensing area. The sensing signal monitoring component 198 may be configured to measure the received reflection of the sensing signal based on at least one of the searching time scope or the SA-SS gap. The sensing signal monitoring component 198 may be configured to calculate a location of the target object based on the measured reflection of the sensing signal. The sensing signal monitoring component 198 may be configured to output a third indicator of the calculated location of the target object. The sensing signal monitoring component 198 may be configured to output the third indicator by transmitting a report message including a third indicator of the calculated location of the target object or by storing the third indicator of the calculated location of the target object. In certain aspects, the UE 104 and/or the base station 102 may have a sensing signal configuration component 199 that may be configured to transmit a configuration message. The configuration message may include a first indicator of a searching time scope associated with a sensing signal and a sensing area or may include a second indicator of a SA-SS gap associated with a SA-SS and the sensing signal. The sensing signal configuration component 199 may be configured to transmit the sensing signal in the sensing area. The sensing signal configuration component 199 may be configured to receive a report message. The report message may include a third indicator of a location of a target object within the sensing area calculated based on the configuration message. In other words, the sensing signal configuration component 199 may transmit a configuration of either a searching time scope or a SA-SS gap to the sensing signal monitoring component 198. The sensing signal monitoring component 198 may measure the sensing signal based on the searching time scope, or may calculate when the sensing signal arrives based on the SA-SS gap and when the SA-SS arrives. Such configurations minimize the resources used by the sensing signal monitoring component 198 to receive and measure the sensing signal.

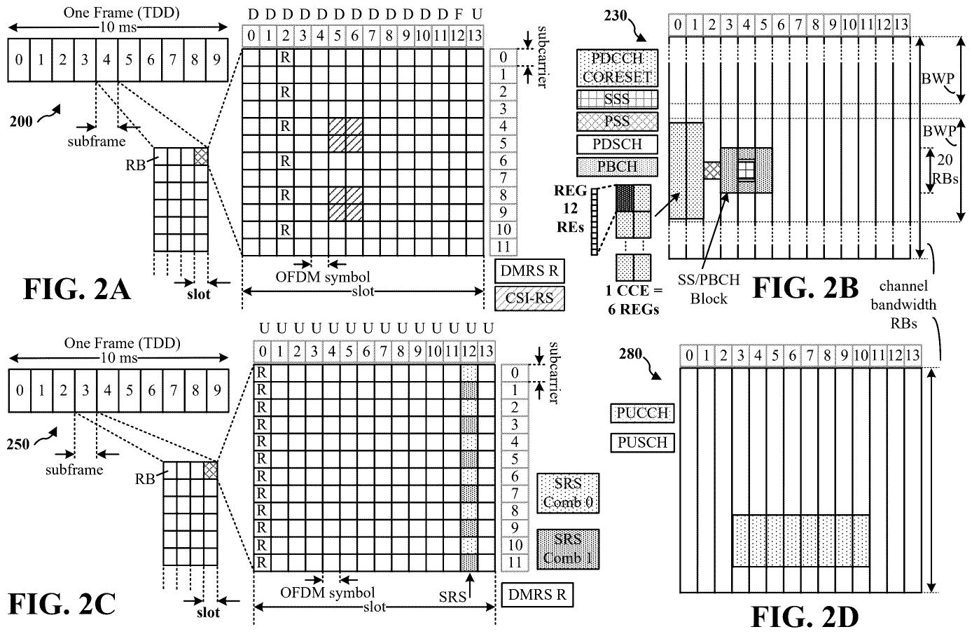

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (for power limited scenarios; limited to a single stream transmission). The number of slots within a subframe is based on the CP and the numerology. The numerology defines the subcarrier spacing (SCS) (see Table 1). The symbol length/duration may scale with 1/SCS.

TABLE 1
Numerology, SCS, and CP

| | SCS | |
|---|---|---|
| μ | Δf = 2^{μ} · 15[kHz] | Cyclic prefix |
| 0 | 15 | Normal |
| 1 | 30 | Normal |
| 2 | 60 | Normal, Extended |
| 3 | 120 | Normal |
| 4 | 240 | Normal |
| 5 | 480 | Normal |
| 6 | 960 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology μ, there are 14 symbols/slot and 2^{μ} slots/subframe. The subcarrier spacing may be equal to 2^{μ}*15 kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

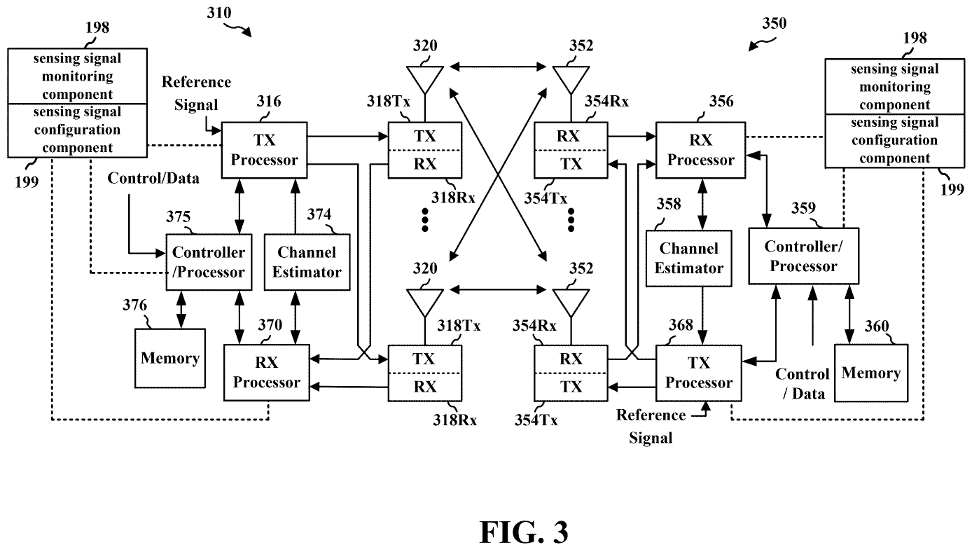

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal includes a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with at least one memory 360 that stores program codes and data. The at least one memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a RX processor 370.

The controller/processor 375 can be associated with at least one memory 376 that stores program codes and data. The at least one memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 368, the RX processor 356, and the controller/processor 359 may be configured to perform aspects in connection with the sensing signal monitoring component 198 of FIG. 1.

At least one of the TX processor 316, the RX processor 370, and the controller/processor 375 may be configured to perform aspects in connection with the sensing signal monitoring component 198 of FIG. 1.

At least one of the TX processor 368, the RX processor 356, and the controller/processor 359 may be configured to perform aspects in connection with the sensing signal configuration component 199 of FIG. 1.

At least one of the TX processor 316, the RX processor 370, and the controller/processor 375 may be configured to perform aspects in connection with the sensing signal configuration component 199 of FIG. 1.

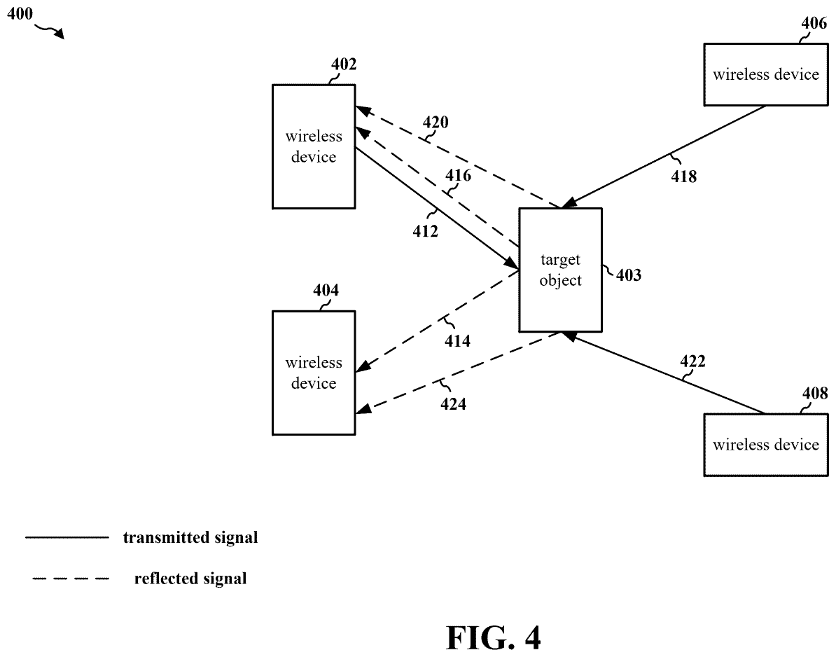

FIG. 4 is a diagram 400 illustrating an example of sensing based on measuring sensing signals transmitted by one or more sensing signals that reflect off of a target object 403. A wireless device that transmits a sensing signal that reflects off of a target object may be referred to as a transmitter node. A wireless device that receives a reflected sensing signal and measures the reflected sensing signal to perform sensing may be referred to as a receiver node. In one aspect, the wireless device 402 may perform monostatic sensing. The wireless device 402 may act as both a transmitter node and a receiver node. The wireless device 402 may transmit a set of sensing signals 412 at the target object 403, the target object 403 may reflect the set of sensing signals 412 as the reflected set of sensing signals 416 at the wireless device 402, and the wireless device 402 may measure the reflected set of sensing signals 416 from the target object 403. In another aspect, the wireless device 402 and the wireless device 404 may perform bistatic sensing. The wireless device 402 may act as a transmitter node and the wireless device 404 acts as a receiver node. The wireless device 402 may transmit a set of sensing signals 412 at the target object 403, the target object 403 may reflect the set of sensing signals 412 as the reflected set of sensing signals 414 at the wireless device 404, and the wireless device 404 may measure the reflected set of sensing signals 414 from the target object 403. In another aspect the wireless device 402 and the wireless device 406 may perform multi-static sensing. The wireless device 402 may act as both a transmitter node and a receiver node, for a first set of sensing signals, and the wireless device 406 acts as a transmitter node while the wireless device 402 acts as a receiver node for a second set of sensing signals. In addition to the wireless device 402 measuring the reflected set of sensing signals 416 from the target object 403 using monostatic sensing, the wireless device 406 may transmit a set of sensing signals 418 at the target object 403, the target object 403 may reflect the set of sensing signals 418 as the reflected set of sensing signals 420 at the wireless device 402, and the wireless device 402 may measure the reflected set of sensing signals 420 from the target object 403. In another aspect the wireless device 402, the wireless device 404, and the wireless device 408 may perform multi-static sensing. The wireless device 402 may act as a transmitter node and the wireless device 404 acts as a receiver node for a first set of sensing signals, and the wireless device 408 acts as a transmitter node and the wireless device 404 acts as a receiver node for a second set of sensing signals. In addition to the wireless device 404 measuring the reflected set of sensing signals 414 from the target object 403 using bistatic sensing, the wireless device 408 may transmit a set of sensing signals 422 at the target object 403, the target object 403 may reflect the set of sensing signals 422 as the reflected set of sensing signals 424 at the wireless device 404, and the wireless device 404 may measure the reflected set of sensing signals 424 from the target object 403. Each wireless device may be any wireless device configured to transmit or receive wireless signals, such as UEs, network nodes, TRPs, or base stations. For example, the wireless device 402 may be a network node configured to transmit the set of sensing signals 412 at the target object 403 and measure the reflected set of sensing signals 416 from the target object 403. In another example, the wireless device 402 may be a network node configured to transmit the set of sensing signals 412 at the target object 403, and the wireless device 404 may be a UE configured to measure the reflected set of sensing signals 414 from the target object 403.

The wireless device 402 may conduct one or more sensing measurements on the reflected set of sensing signals 416 and/or the reflected set of sensing signals 420. In one aspect, the wireless device 402 may calculate a distance or a range between the wireless device 402 and the target object 403 based on a round trip time (RTT) between when the wireless device 402 transmits the set of sensing signals 412 and when the wireless device 402 receives the reflected set of sensing signals 416. In one aspect, the wireless device 402 may calculate a distance or a range that the set of sensing signals 418 and the reflected set of sensing signals 420 travels based on a time between when the wireless device 406 transmits the set of sensing signals 418 and when the wireless device 402 receives the reflected set of sensing signals 420. In one aspect, the wireless device 402 may calculate a location of the target object 403 based on a plurality or range or distance measurements, for example via triangulation using known positions of the wireless devices 402 and 406 and the calculated range or distance measurements. In one aspect, the wireless device 402 may calculate a velocity of the target object 403 based on a first calculated location of the target object 403 based on the reflected set of sensing signals 416 and/or the reflected set of sensing signals 420 measured at a first time, and a second calculated location of the target object 403 based on the reflected set of sensing signals 416 and/or the reflected set of sensing signals 420 measured at a second time. In one aspect, the wireless device 402 may calculate an AoA of the reflected set of sensing signals 416 and/or an AoD of the set of sensing signals 412 based on a plurality of ports that transmitted the set of sensing signals 412 and a plurality of ports that received the reflected set of sensing signals 416. In one aspect, the wireless device 402 may calculate an AoA of the reflected set of sensing signals 420 and/or an AoD of the set of sensing signals 418 based on a plurality of ports that transmitted the set of sensing signals 418 and a plurality of ports that received the reflected set of sensing signals 420.

Similarly, the wireless device 404 may conduct one or more sensing measurements on the reflected set of sensing signals 414 and/or the reflected set of sensing signals 424. In one aspect, the wireless device 404 may calculate a distance or a range that the set of sensing signals 412 and the reflected set of sensing signals 414 travels based on a time between when the wireless device 402 transmits the set of sensing signals 412 and when the wireless device 404 receives the reflected set of sensing signals 414. In one aspect, the wireless device 404 may calculate a distance or a range that the set of sensing signals 422 and the reflected set of sensing signals 424 travels based on a time between when the wireless device 408 transmits the set of sensing signals 422 and when the wireless device 404 receives the reflected set of sensing signals 424. In one aspect, the wireless device 404 may calculate a location of the target object 403 based on a plurality or range or distance measurements, for example via triangulation using the known positions of wireless devices 402, 404, and 408, and the calculated range or distance measurements. In one aspect, the wireless device 404 may calculate a velocity of the target object 403 based on a first calculated location of the target object 403 based on the reflected set of sensing signals 414 and/or the reflected set of sensing signals 424 measured at a first time, and a second calculated location of the target object 403 based on the reflected set of sensing signals 414 and/or the reflected set of sensing signals 424 measured at a second time. In one aspect, the wireless device 404 may calculate an AoA of the reflected set of sensing signals 414 and/or an AoD of the set of sensing signals 412 based on a plurality of ports that transmitted the set of sensing signals 412 and a plurality of ports that received the reflected set of sensing signals 414. In one aspect, the wireless device 404 may calculate an AoA of the reflected set of sensing signals 424 and/or an AoD of the set of sensing signals 422 based on a plurality of ports that transmitted the set of sensing signals 422 and a plurality of ports that received the reflected set of sensing signals 424.

While a wireless device may sense parameters of the target object 403 by measuring a reflected set of sensing signals originating from a transmitter node, such a wireless device may improve its sensing by measuring two or more reflected sets of sensing signals originating from two or more transmitter nodes. For example, the wireless device 402 may improve its sensing by measuring the reflected set of sensing signals 416 originating from the wireless device 402 as the set of sensing signals 412 in addition to measuring the reflected set of sensing signals 420 originating from the wireless device 406 as the set of sensing signals 418. In another example, the wireless device 404 may improve its sensing by measuring the reflected set of sensing signals 414 originating from the wireless device 402 as the set of sensing signals 412 in addition to measuring the reflected set of sensing signals 424 originating from the wireless device 408 as the set of sensing signals 422.

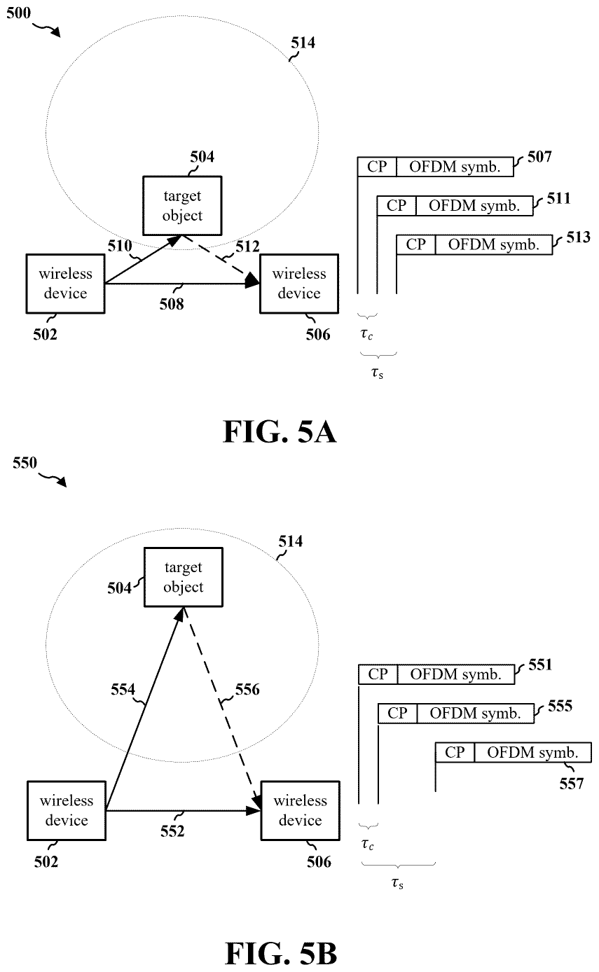

FIG. 5A is a diagram 500 illustrating an example of a wireless device 502 transmitting a set of communication signals 508 at a wireless device 506 and a set of sensing signals 510 at a target object 504. The set of sensing signals 510 may reflect off of the target object 504 as the set of reflected sensing signals 512. The wireless device 506 may receive the set of reflected sensing signals 512.

The wireless device 502 may be a wireless device configured to transmit sensing signals and communication signals, such as a network node or a UE. The wireless device 506 may be a wireless device configured to receive and measure sensing signals and to receive and decode communication signals, such as a UE or a network node. The target object 504 may be any object capable of reflecting at least some RF signals, for example an unmanned aerial vehicle (UAV) or a human being. The target object 504 may be within a sensing area 514, which is an area where a sensing signal may be transmitted from the wireless device 502 to be received by the wireless device 506 with enough integrity (e.g., having an RSRP greater or equal to a threshold value) such that the wireless device 506 may calculate a set of location attributes, for example a distance between the target object 504 and the wireless device 506, an AoA/AoD of the set of sensing signals 510, or an AoA/AoD of the set of reflected sensing signals 512.

In order to improve spectrum efficiency, the wireless device 502 may use an integrated ISAC waveform for simultaneous communication and sensing. In other words, one ISAC waveform may be used for both communication and sensing. In some aspects, the ISAC waveform may use OFDM for its good flexibility and backward compatibility. The wireless device 502 may distribute the sensing subcarriers in an OFDM symbol in a frequency domain, while using the other subcarriers for communication. For example, the wireless device 502 may transmit a transmission signal 507 as a CP followed by an OFDM symbol with some subcarriers used for communication and other subcarriers used for sensing. While the diagram 500 illustrates the wireless device 502 transmitting a set of communication signals 508 and a set of sensing signals 510, it should be understood that the wireless device 502 may transmit a single transmission that may include OFDM symbols with a first subset of subcarriers used for sensing and a second subset of subcarriers used for communication.

In some aspects, the distance that the sensing signals travel may be small enough that the propagation delay of the communication signals (Tc) are similar to the propagation delay of the sensing signals (Ts). For example, as shown in FIG. 5A, the time between when the wireless device 502 transmits the transmission signal 507 and the time when the wireless device 506 receives the transmission signal 507 as the reception signal 511 (i.e., the set of communication signals 508) may be calculated as τ_{c}. The delay τ_{c} may be calculated based on the distance between the wireless device 502 and the wireless device 506 (i.e., the distance that the set of communication signals 508 travels). Similarly, the time between when the wireless device 502 transmits the transmission signal 507 and the time when the wireless device 506 receives the transmission signal 507 as the reception signal 513 (i.e., the set of reflected sensing signals 512) may be calculated as τₛ. The delay τₛ may be calculated based on (1) the distance between the wireless device 502 and the target object 504 (i.e., the distance that the set of sensing signals 510 travels) and (2) the distance between the target object 504 and the wireless device 506 (i.e., the distance that the set of reflected sensing signals 512 travels). In such aspects, the difference between the propagation delays (τₛ−τ_{c}) may be less than the length of the CP (T_{CP}). In some aspects, the difference between the calculated the value and the calculated Ts may be larger.

FIG. 5B is a diagram 550 illustrating an example of the wireless device 502 transmitting a set of communication signals 552 at the wireless device 506 and a set of sensing signals 554 at the target object 504 in a different location within the sensing area 514 than in FIG. 5A. The set of sensing signals 554 may reflect off of the target object 504 as the set of reflected sensing signals 556. The wireless device 506 may receive the set of reflected sensing signals 556.

As shown in FIG. 5B, the distance that the sensing signals travel may be so large that the propagation delay of the communication signals (τ_{c}) may be much smaller than the propagation delay of the sensing signals (τₛ). For example, the time between when the wireless device 502 transmits the transmission signal 551 and the time when the wireless device 506 receives the transmission signal 551 as the reception signal 555 (i.e., the set of communication signals 552) may be calculated as τ_{c}. The delay τ_{c} may be calculated based on the distance between the wireless device 502 and the wireless device 506 (i.e., the distance that the set of communication signals 552 travels). Similarly, the time between when the wireless device 502 transmits the transmission signal 551 and the time when the wireless device 506 receives the transmission signal 551 as the reception signal 557 (i.e., the set of reflected sensing signals 556) may be calculated as τₛ. The delay τₛ may be calculated based on (1) the distance between the wireless device 502 and the target object 504 (i.e., the distance that the set of sensing signals 554 travels) and (2) the distance between the target object 504 and the wireless device 506 (i.e., the distance that the set of reflected sensing signals 556 travels). Such aspects may occur where the target object 504 is located outside a cell, but is within sensing range of the wireless device 506. In such aspects, the difference between the propagation delays (τₛ−τ_{c}) may be larger than the length of the CP (T_{CP}). Performing sensing with an integrated OFDM waveform with such lengthy delays may cause problems with accurately receiving and measuring the reflected sensing signals.

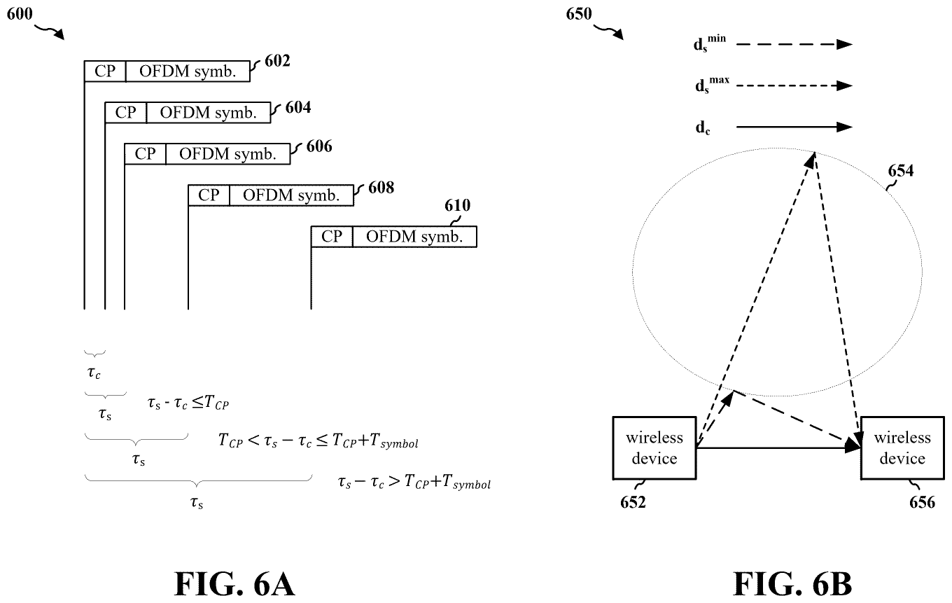

FIG. 6A is a diagram 600 illustrating an example of sensing and communication signals that may be received at a receiver with different relative delays. As used herein, an OFDM symbol configured to propagate along a communication/sensing link may be referred to as a communication/sensing symbol.

A first wireless device (e.g., a base station) configured to transmit a communication/sensing symbol may transmit a transmission signal 602 having an OFDM symbol with a length T_{symbol}, including a CP with a length T_{CP} and an OFDM output with a length T_{OFDM}, i.e., T_{symbol}=T_{CP}+T_{OFDM}. A second wireless device (e.g., a UE) configured to receive a communication/sensing symbol may receive the transmission signal 602 at two different times, once directly from the first wireless device via a communication path, and a second time indirectly as reflected off of a target object via a sensing path. In one aspect, the target object may be located close to the first and the second wireless device. For example, the first wireless device may transmit the transmission signal 602, and the second wireless device may receive the transmission signal 602 at a first time as the reception signal 604 directly from the first wireless device, and may receive the transmission signal 602 at a second time as the reception signal 606 indirectly as reflected off of a target object. In this example, the difference between the propagation delays may be less than or equal to the length of the CP. In other words, τₛ−τ_{c}≤T_{CP}. The second wireless device may use the sampling window for communication to receive the sensing symbol, obtaining a complete cyclic-shifted OFDM sensing symbol. In this example, the sensing performance may not degrade as τₛ−τ_{c}≤T_{CP}.

In another aspect, the target object may be located a little further from the first and the second wireless device. For example, the first wireless device may transmit the transmission signal 602, and the second wireless device may receive the transmission signal 602 at a first time as the reception signal 604 directly from the first wireless device, and may receive the transmission signal 602 at a second time as the reception signal 608 indirectly as reflected off of a target object. In this example, the difference between the propagation delays may be greater than the length of the CP. In other words, T_{CP}<τₛ−τ_{c}. While the second wireless device may use the sampling window for communication to receive the sensing symbol, the second wireless device may not obtain a complete cyclic-shifted OFDM sensing symbol. If the difference between the propagation delays is less than or equal to the length of the OFDM sensing symbol (i.e., τₛ−τ_{c}≤T_{symbol}), then the second wireless device may receive a partial cyclic-shifted OFDM sensing symbol. While the second wireless device may have degraded sensing performance, the second wireless device may still be able to accurately calculate the location of the target object within a threshold degree of accuracy.

In another aspect, the target object may be located even further from the first and the second wireless device. For example, the first wireless device may transmit the transmission signal 602, and the second wireless device may receive the transmission signal 602 at a first time as the reception signal 604 directly from the first wireless device, and may receive the transmission signal 602 at a second time as the reception signal 610 indirectly as reflected off of a target object. In this example, the difference between the propagation delays may be greater than the length of the ODFM sensing symbol. In other words, τₛ−τ_{c}>T_{symbol}. In this aspect, if the second wireless device uses the sampling window for communication to receive the sensing symbol, the second wireless device may not obtain any of the cyclic-shifted OFDM sensing symbol. In order for the second wireless device to receive and measure the sensing symbol if τₛ−τ_{c}>T_{symbol}, the second wireless device may search for the sensing symbol in a time duration after receiving the reception signal 604 (e.g., in a sliding window). However, since a sensing signal typically has a large bandwidth to estimate a delay with a high degree of precision, monitoring for the sensing symbol may use a great deal of resources. For example, a great deal of calculations may be used to calculate the correlation between the reception signal 610 and the transmission signal 602. Such calculations may use a great deal of power. Moreover, reference signals typically used for sensing (e.g., PRS, CSI-RS, tracking reference signal (TRS)) may not have good time-domain auto-correlation characteristics. As a result, the second wireless device may not accurately detect such sensing signals, as the second wireless device may have a high miss detection ration and/or a high false alarm ratio.

In some aspects, the second wireless device may decrease the amount of power used to search for a sensing signal by calculating a searching time scope associated with the sensing signal. A searching time scope may be a scope of time that bounds the time periods that the sensing signal may be received at the second wireless device configured to receive a communication signal and a sensing signal.

FIG. 6B is a diagram 650 illustrating an example of a wireless device 652 configured to calculate a searching time scope based on a minimum and maximum sensing distance of a sensing area 654. The wireless device 652 may know the boundaries of the sensing area 654, for example if the wireless device 652 configures a sensing session to sense a target object within a room, the wireless device 652 may limit the borders of sensed objects to the borders of the room. In another example, if the wireless device 652 configures a sensing session to sense an unmanned aerial vehicle (UAV) in a regulated area, the wireless device 652 may limit the height of sensed objects in an area to a maximum UAV height (e.g., 120 meters). In another example, if the wireless device 652 configures a sensing session to sense a vehicle on a road, the wireless device 652 may limit the height of sensed objects in an area to the borders of the road. The wireless device 652 may know the location of the wireless device 656 relative to the wireless device 652. For example, the wireless device 652 may perform positioning with the wireless device 656 to determine the location of the wireless device 656 relative to the wireless device 652. In another example, the wireless device 656 may have an accurate sensor (e.g., a GPS or a GNSS device) that may provide a location of the wireless device 656 to the wireless device 652. In another example, an LMF may know the location of the wireless device 656 and may transmit the location of the wireless device 656 to the wireless device 652.

The wireless device 652 may calculate the minimum sensing signal propagation distance from the wireless device 652 to a closest point within the sensing area 654 back to the wireless device 656

$$( {d}_{s}^{min} ) .$$

The wireless device 652 may calculate the maximum sensing signal propagation distance from the wireless device 652 to a furthest point within the sensing area 654 back to the wireless device 656

$$( {d}_{s}^{max} ) .$$

Based on the knowledge, or the estimate, of the location of the wireless device 656, the wireless device 652 may calculate

$${d}_{s}^{min} and {d}_{s}^{max} .$$

The wireless device 652 may calculate the time scope of the sensing signal detection based on a minimum sensing signal propagation delay

$$( {τ}_{s}^{m i n} ) ,$$

for example, as

$${τ}_{s}^{m i n} = \frac{{d}_{s}^{m i n}}{c} - {τ}_{c} .$$

$${d}_{s}^{m i n}$$

may be the speed of light.

τ_{c} may be the estimated communication signal propagation delay from the wireless device 652 to the wireless device 656, which may be estimated as

$${τ}_{c} = \frac{TA}{2} ,$$

where TA is the UL transmission timing advance value for the wireless device 656, or may be estimated as

$$\frac{{d}_{c}}{c} ,$$

where d_{c} is the estimated distance between the wireless device 652 and the wireless device 656.

The wireless device 652 may calculate the time scope of the sensing signal detection based on a maximum sensing signal propagation delay

$$( {t}_{s}^{m ax} ) ,$$

for example, as

$${t}_{s}^{m ax} = \frac{{d}_{s}^{m ax}}{c} - {τ}_{c} .$$

$${d}_{s}^{m ax}$$

may be the maximum sensing signal propagation distance.

In some aspects, the wireless device 652 may transmit a message to the wireless device 656, indicating the calculated information on

$${τ}_{s}^{m i n} and {t}_{s}^{m ax} ,$$

where

$${τ}_{s}^{m i n} \leq {τ}_{s}^{m ax} .$$

In one aspect, the wireless device 652 may indicate the real values of

$${τ}_{s}^{m i n} and {t}_{s}^{m ax} .$$

In another aspect, the wireless device 652 may indicate the OFDM symbol index that corresponds to

$${τ}_{s}^{m i n} and {t}_{s}^{m ax} .$$

For example, the wireless device 652 may transmit an OFDM symbol

$${i}_{s}^{m i n}$$

such that

$${τ}_{s}^{m i n}$$

is in the OFDM symbol

$${i}_{s}^{m i n} ,$$

and may transmit an OFDM symbol

$${i}_{s}^{m ax}$$

such that

$${τ}_{s}^{m ax}$$

is the OFDM symbol

$${i}_{s}^{ma x} .$$

Once the wireless device 656 has an indication of

$${τ}_{s}^{m i n} and {τ}_{s}^{m ax} ,$$

the wireless device 656 may search the time scope from

$${τ}_{s}^{m i n}$$

to

$${τ}_{s}^{m ax} + {T}_{symbol} ,$$

of from OFDM symbol

$${i}_{s}^{m i n}$$

to OFDM symbol

$${τ}_{s}^{m ax} + 1.$$

This reduces the calculation amount and latency of the wireless device 656 to search for the sensing signal, and may also save the amount of power used by the wireless device 656 to search for the sensing signal.

In some aspects, the behavior of the wireless device 656 may change based on the indicated searching time scope.

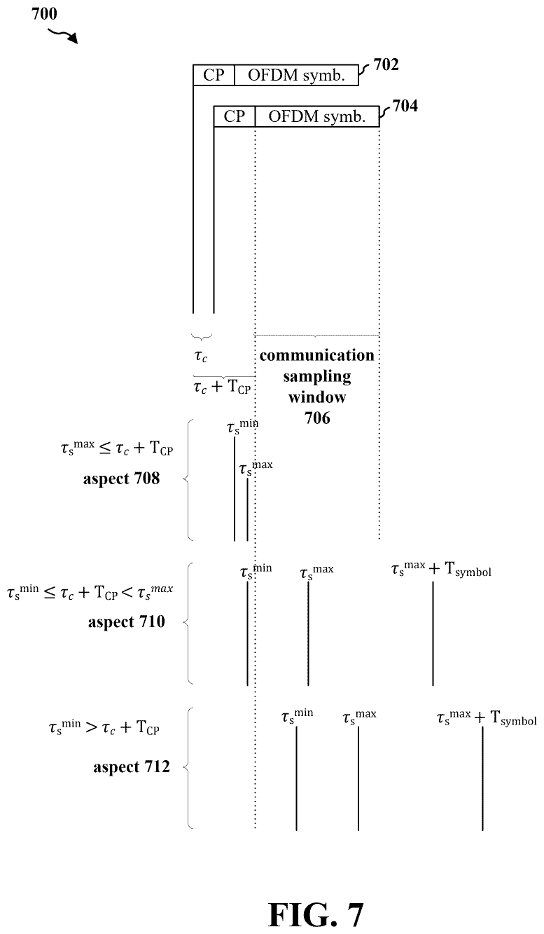

FIG. 7 is a diagram 700 illustrating an example of sensing and communication signals that are received at a receiver device with different relative delays between the sensing signal and the communication signal. The communication/sensing symbol may be transmitted as the transmission signal 702, and may be received and decoded for communication as the reception signal 704 after a communications propagation delay (τ_{c}). The length of the CP of the reception signal 704 may be denoted as T_{CP}. The length of the ODFM symbol may be denoted as T_{symbol}. The receiver device may decode the reception signal 704 based on the communication sampling window 706 from τ_{c}+T_{CP} to τ_{c}+T_{symbol}.

In aspect 708, the searching time scope may indicate a maximum searching time scope delay

$$( {τ}_{s}^{m ax} )$$

that is less than or equal to τ_{c}+T_{CP}

$$( i . e . , {τ}_{s}^{m ax} \leq {T}_{CP} ) .$$

### If

$${τ}_{s}^{m ax} \leq {T}_{CP} ,$$

then the receiver device may receive the sensing signal in the communication sampling window 706 for communication of the OFDM symbol where the sensing signal is transmitted in the transmission signal 702. In other words, the receiver device may not search for the sensing signal, as the receiver device may use the communication sampling window 706 for both communication and sensing.

In aspect 710, the searching time scope may indicate a maximum searching time scope delay

$$( {τ}_{s}^{m ax} )$$

that is greater than τ_{c}+T_{CP} (i.e., τ_{c}+T_{CP}<τₛ^{max}). The searching time scope may also indicate a minimum searching time scope delay

$$( {τ}_{s}^{m i n} )$$

that is less than or equal to τ_{c}+T_{CP} (i.e., τₛ^{min}≤τ_{c}+T_{CP}). In some aspects, if τₛ^{min}≤τ_{c}+T_{CP}<τₛ^{max}, then the receiver device may receive the sensing signal in the communication sampling window 706 for communication of the OFDM symbol where the sensing signal is transmitted in the transmission signal 702. In other words, the receiver device may not search for the sensing signal, as the receiver device may use the communication sampling window 706 for both communication and sensing. In other aspects, the receiver device may not receive enough of the sensing symbol (e.g., the receiver device may receive less than 80% of the OFDM symbol, or the received sensing signal may have an RSRP less than or equal to a threshold value). If the received sensing signal in the communication sampling window 706 is not long enough to adequately perform sensing, the receiver device may monitor for the sensing signal from T_{CP} to

$${τ}_{s}^{m ax} + {T}_{symbol} .$$

In other words, the receiver device may bound the time period that it searches/monitors for the sensing signal by T_{CP} and

$${τ}_{s}^{m ax} .$$

In aspect 712, the searching time scope may indicate a minimum searching time scope delay

$$( {τ}_{s}^{min} )$$

that is greater than τ_{c}+T_{CP} (i.e., τₛ^{min}>τ_{c}+T_{CP}). If τₛ^{min}>τ_{c}+T_{CP}, then the receiver device may not be able to receive the sensing signal in the communication sampling window 706. The receiver device may monitor for the sensing signal from

$${τ}_{s}^{min} to {τ}_{s}^{max} + {T}_{symbol} .$$

In other words, the receiver device may bound the time period that it searches/monitors for the sensing signal by the indicators of indication of

$${τ}_{s}^{min} and {τ}_{s}^{max} .$$

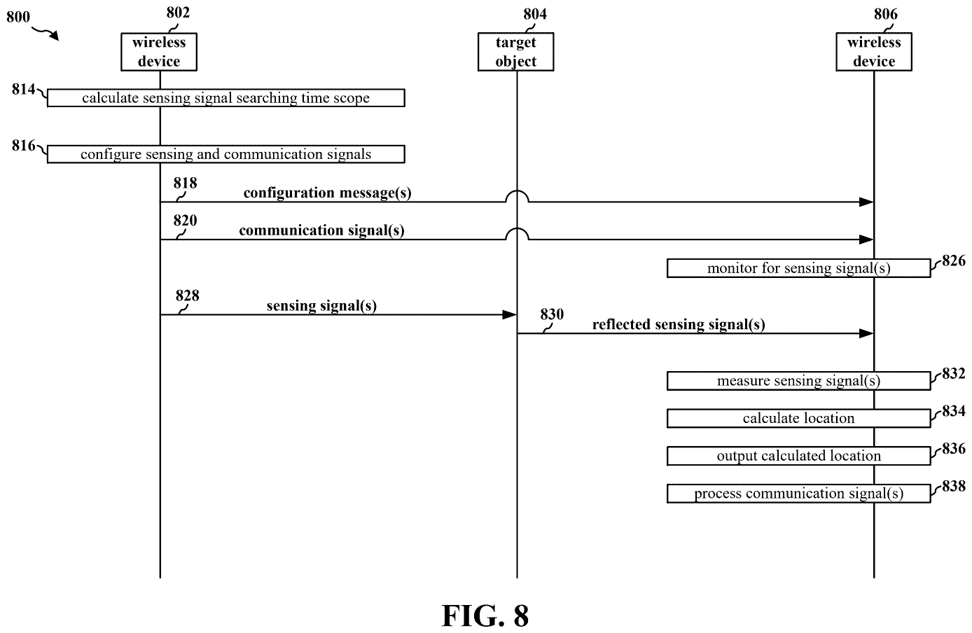

FIG. 8 is a communication flow diagram 800 illustrating an example of a wireless device 802 configured to transmit a set of communication/sensing symbols at a wireless device 806 for both a communication session and a sensing session. The wireless device 802 may be a network node, a TRP, or a UE. The wireless device 806 may be a UE, a TRP, or a network node.

At 814, the wireless device 802 may calculate a sensing signal searching time scope based on a sensing area, for example similar to the sensing area 654 in FIG. 6B. The wireless device 802 may calculate a minimum sensing signal propagation delay

$$( {τ}_{s}^{min} )$$

and a maximum sensing signal propagation delay

$$( {τ}_{s}^{max} )$$

based on the sensing area. The target object 804 may be within the sensing area.

At 816, the wireless device 802 may configure the sensing and communication signals for communicating with the wireless device 806, and for performing sensing on the sensing area that the target object 804 is within with the wireless device 806. The wireless device 802 may use an integrated ISAC waveform for simultaneous communication and sensing. The wireless device 802 may distribute the sensing subcarriers in an OFDM symbol in a frequency domain, while using the other subcarriers for communication. Thus, while the set of communication signals 820 and the set of sensing signals 828 are shown in the communication flow diagram 800 as separate transmissions, it should be understood that the set of communication signals 820 and the set of sensing signals 828 may be transmitted in an integrated ISAC OFDM waveform for simultaneous communication and sensing be distributing sensing subcarriers in an OFDM symbol having communication subcarriers.

The wireless device 802 may transmit a set of configuration messages 818 to the wireless device 806. The wireless device 806 may receive the set of configuration messages 818 from the wireless device 802. The set of configuration messages 818 may include an indicator of the searching time scope associated with the set of sensing signals 828. For example, the set of configuration messages 818 may include an indicator of the calculated

$${τ}_{s}^{min}$$

and an indicator of the calculated

$${τ}_{s}^{max} .$$

The set of configuration messages 818 may include an indicator of an OFDM symbol

$${i}_{s}^{min}$$

that is correlated with the calculated

$${τ}_{s}^{min} ,$$

and an indicator of an OFDM symbol

$${i}_{s}^{max}$$

that is correlated with the calculated

$${τ}_{s}^{max} .$$

In some aspects, the set of configuration messages 818 may include at least one of a radio resource control (RRC) message, a medium access control (MAC) control element (MAC-CE), or downlink control information (DCI). For example, an RRC message may include a set of potential propagation delay values, and a MAC-CE or DCI may include an index to the set of propagation delay values.

The wireless device 802 may transmit the set of communication signals 820 to the wireless device 806. The wireless device 806 may receive the set of communication signals 820 from the wireless device 802. The wireless device 802 may transmit the set of sensing signals 828 at the sensing area that the target object 804 is in. The set of sensing signals 828 may reflect off of the target object 804 as the set of reflected sensing signals 830. The wireless device 806 may receive the set of reflected sensing signals 830 from the target object 804. The wireless device 802 may transmit the set of communication signals 820 and the set of sensing signals 828 as an integrated ISAC waveform for simultaneous communication and sensing.

At 826, the wireless device 806 may monitor for the set of reflected sensing signals 830 based on the set of configuration messages 818. In one aspect, if

$${τ}_{s}^{max} \leq {T}_{CP} ,$$

the wireless device 806 may monitor for the set of reflected sensing signals 830 in the communication sampling window for the set of communication signals 820. In another aspect, if

$${τ}_{s}^{min} \leq {τ}_{c} + {T}_{CP} < {τ}_{s}^{max} ,$$

the wireless device 806 may first monitor for the set of reflected sensing signals 830 in the communication sampling window for the set of communication signals 820, but if the received sensing signals are insufficient, the wireless device 806 may continue to monitor for the set of reflected sensing signals 830 until

$${τ}_{s}^{max} + {T}_{symbol} .$$

In another aspect, if

$${τ}_{s}^{min} > {τ}_{c} + {T}_{CP} ,$$

the wireless device 806 may monitor for the set of reflected sensing signals 830 from

$${τ}_{s}^{min} to {τ}_{s}^{max} + {T}_{symbol} .$$

At 832, the wireless device 806 may measure the set of reflected sensing signals 830. At 834, the wireless device 806 may calculate a location of the target object 804. At 836, the wireless device 806 may output the calculated location of the target object 804. For example, the wireless device 806 may transmit the calculated location of the target object in a report message that is transmitted to another wireless device, such as the wireless device 802 or a component of a core network, such as an LMF. In another example, the wireless device 806 may output the calculated location of the target object to a component of the wireless device 806, which may save the calculated location to a memory, such as a drive or a cache, of the wireless device 806.

At 838, the wireless device 806 may process the set of communication signals 820. For example, the wireless device 806 may decode the set of communication signals 820 and follow a set of instructions in according to the decoded signals. While the communication flow diagram 800 illustrates that the wireless device 806 may process the set of communication signals 820 at 838 after monitoring for the set of reflected sensing signals 830 at 826, the wireless device 806 may process the set of communication signals 820 at 838 before monitoring for the set of reflected sensing signals 830 at 826, or may perform both concurrently.

While the aspect disclosed in FIG. 8 may reduce the amount of time the wireless device 806 uses to search for a sensing signal when receiving a waveform for simultaneous communication and sensing, a sensing signal may have a large bandwidth to estimate a delay with a high degree of precision. As a result, monitoring for a sensing signal may use a great deal of resources, even if the time the wireless device 806 uses to monitor for the sensing signal is reduced using a searching time scope. In some aspects, a transmitting device may be configured to transmit a sensing-associated sensing signal (SA-SS) prior to transmitting a sensing signal with a configured gap between the SA-SS and the sensing signal to further reduce the resources used to search for a sensing signal.

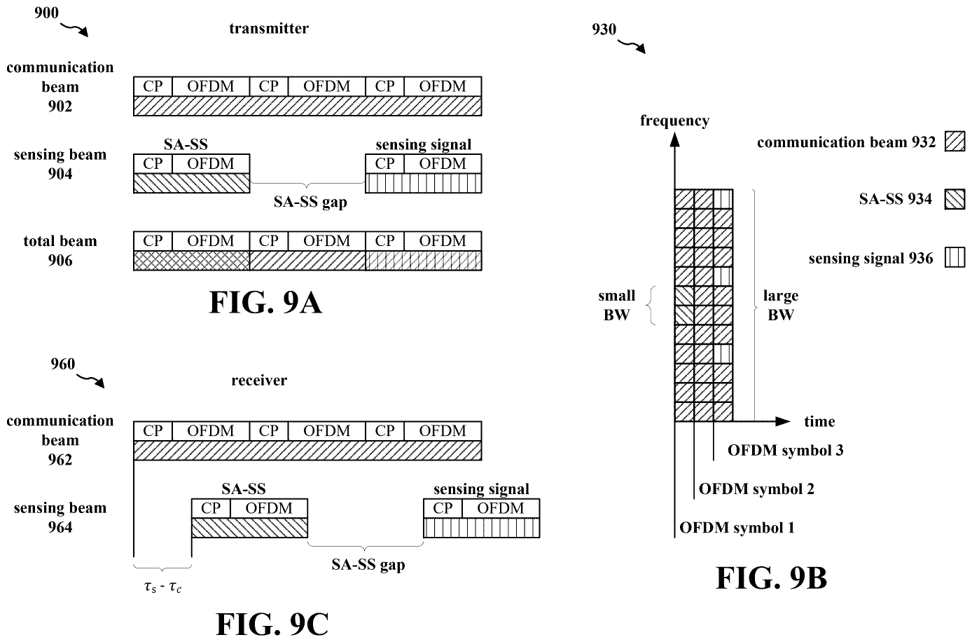

FIG. 9A is a diagram 900 illustrating an example of a communication beam 902 and sensing beam 904 transmitted simultaneously from a transmitting device using a waveform for simultaneous communication and sensing. The communication beam 902 may include a set of consecutive OFDM symbols used for communication to a receiver device. While the diagram 900 illustrates three consecutive OFDM symbols, a communication beam may include more or less consecutive OFDM symbols in other aspects.

The sensing beam 904 may include two transmissions, a first transmission of a SA-SS and a second transmission of a sensing signal. The sensing signal may be transmitted after a configured gap. The transmitter device may configure the gap between the SA-SS and the sensing signal. While the diagram 900 illustrates the configured SA-SS gap between the SA-SS and the sensing signal to be a single OFDM symbol, the configured SA-SS gap may be longer or shorter than an OFDM symbol in other aspects. The communication beam 902 and the sensing beam 904 may be multiplexed in OFDM symbols as the total beam 906.

FIG. 9B is a diagram 930 illustrating an example of the resource elements (REs) of the communication beam 902 and the sensing beam 904 of FIG. 9A. In other words, the diagram 930 is a RE view of the total beam 906 in FIG. 9A. The total beam 906 may include REs for the communication beam 932, REs for the SA-SS 934, and REs for the sensing signal 936. As shown, the SA-SS 934 may have a small BW as compared with the large BW of the sensing signal 936. As a result, a receiver device monitoring for the SA-SS of the sensing beam 904 may use less resources than a receiver device monitoring for the sensing signal of the sensing beam 904.

FIG. 9C is a diagram 960 illustrating an example of a communication beam 962 and a sensing beam 964 received simultaneously at a receiver device. The communication beam 962 may be the communication beam 902 in FIG. 9A received at the receiver device, which may be received after a propagation delay of τ_{c}. The sensing beam 964 may be the sensing beam 904 in FIG. 9A received at the receiver device, which may reflect off of a target device to be received at the receiver device after a propagation delay of τₛ. If τₛ−τ_{c}>T_{CP}, the receiver device may search for the sensing symbol in the time domain. By using the SA-SS, the receiver device may improve the performance by searching for the small BW in FIG. 9B instead of the large BW in FIG. 9B.

The receiver device may search for the small BW of the SA-SS in the sensing beam 904, and then may calculate when the receiver device will receive the sensing signal in the sensing beam 904. The receiver device may then search for the large BW of the sensing signal in the sensing beam 904 after the SA-SS gap, conserving resources. In some aspects, the receiver device may search for the SA-SS using a plurality of sliding windows.

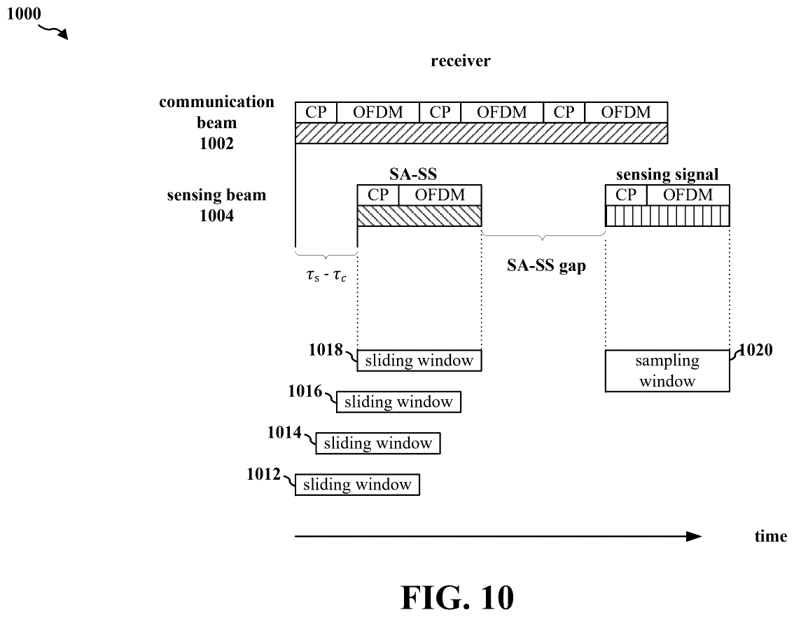

FIG. 10 is a diagram 1000 illustrating an example of a plurality of sliding windows used to determine when a SA-SS may be received by a receiver device. The receiver device may receive a communication beam 1002 and a sensing beam 1004 similar to the communication beam 962 and the sensing beam 964, respectively, in FIG. 9C. The receiver device may first monitor the sliding window 1012 for the SA-SS, starting to monitor when the receiver device receives the communication beam 1002. If the receiver device does not find the SA-SS in the sliding window 1012, the receiver device may then monitor the sliding window 1014 for the SA-SS. If the receiver device does not find the SA-SS in the sliding window 1014, the receiver device may then monitor the sliding window 1016 for the SA-SS. If the receiver device does not find the SA-SS in the sliding window 1016, the receiver device may then monitor the sliding window 1018 for the SA-SS. As the SA-SS is received in the sliding window 1018 for the SA-SS, the receiver device may stop monitoring, and may calculate when the sensing signal will arrive after the configured SA-SS gap. In some aspects, the receiver may determine that the SA-SS is received in a sliding window based on a correlation result. For example, the receiver device may accept a sliding window as being sufficient to receive the SA-SS when a calculated correlation result (e.g., a correlation coefficient) is larger than a threshold amount (E.g., 90%). The receiver device may then monitor for the sensing signal of the sensing beam 1004 using the sampling window 1020. The sampling window 1020 may have a large BW while each of the sliding window 1012, the sliding window 1014, the sliding window 1016, and the sliding window 1018 may have a small BW, conserving resources by using the sliding window.

In some aspects, a transmitter device may transmit an indicator of a search scope for the SA-SS, minimizing the range that the receiver device uses to search for the SA-SS using the plurality of sliding windows.

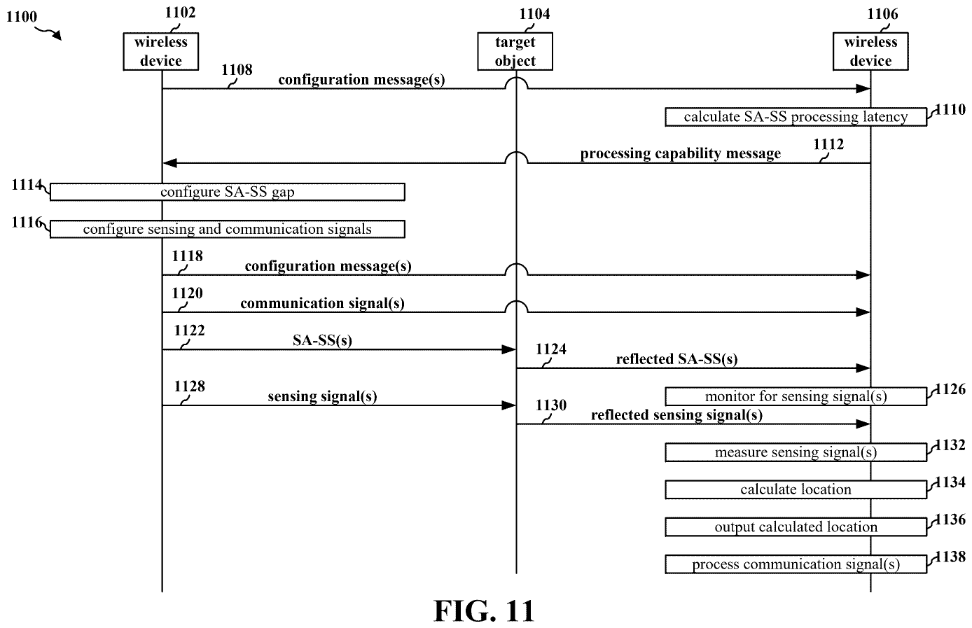

FIG. 11 is a communication flow diagram 1100 illustrating an example of a wireless device 1102 configured to transmit a set of communication/sensing symbols at a wireless device 1106 for both a communication session and a sensing session. The wireless device 1102 may be a network node, a TRP, or a UE. The wireless device 1106 may be a UE, a TRP, or a network node.

The wireless device 1102 may transmit a set of configuration messages 1108 at the wireless device 1106. The wireless device 1106 may receive the set of configuration messages 1108. The set of configuration messages 1108 may include a SA-SS configuration for the set of SA-SSs 1122, such as a bandwidth for the set of SA-SSs 1122 or an offset for the set of SA-SSs 1122. The transmission direction of the set of SA-SSs 1122 may be the same direction as transmission direction of the set of sensing signals 1128. The BW of the set of SA-SSs 1122 may be smaller than the BW of the set of sensing signals 1128. The transmission power that the wireless device 1102 uses may be calculated based on a difference of sensitivity between the set of SA-SSs 1122 and the set of sensing signals 1128. In other words, the wireless device 1102 may increase or decrease the transmission power of the set of SA-SSs 1122 to be within a threshold value of the transmission power of the set of sensing signals 1128, ensuring that the coverage of the set of sensing signals 1128 is approximately the same as the coverage of the set of sensing signals 1128. In some aspects, the set of configuration messages 1108 may include at least one of an RRC message, a MAC-CE, or DCI. For example, an RRC message may include a set of potential SA-SS BWs, and a MAC-CE or DCI may include an index to the set of SA-SS BWs.

At 1110, the wireless device 1106 may calculate the processing latency to process a SA-SS of the set of SA-SSs 1122. The processing latency may be expressed in a number of symbols or a number of slots that the wireless device 1106 estimates it will use to monitor/detect/search for a SA-SS. The processing latency may be calculated from the time occasion when the SA-SS arrives at the wireless device 1106 to the time occasion when the wireless device 1106 detects the SA-SS. The processing latency may be based on the implementation of the wireless device 1106, such as computation speed and/or storage size.

The wireless device 1106 may transmit a processing capability message 1112 at the wireless device 1102. The wireless device 1102 may receive the processing capability message 1112 from the wireless device 1106. The processing capability message 1112 may include an indicator of the calculated processing latency that was calculated at 1110.

At 1114, the wireless device 1102 may configure a SA-SS gap between the SA-SS and the sensing signal. The wireless device 1102 may configure the SA-SS gap to be small enough to make the channel state not change from the SA-SS to the sensing signal, and large enough for the wireless device 1106 to detect the SA-SS before the arrival of sensing signal. In some aspects, the wireless device 1102 may configure the SA-SS gap to be the smallest gap length greater or equal to the calculated processing latency indicated in the processing capability message 1112. In some aspects, the wireless device 1102 may configure the set of SA-SSs 1122 to be transmitted periodically (e.g., associated with a periodic sensing RS). In other aspects, the wireless device 1102 may configure the set of SA-SSs 1122 to be transmitted aperiodically (e.g., associated with an aperiodic sensing RS). For example, the wireless device 1102 may transmit a sensing signal in response to an event trigger. In some aspects, the wireless device 1102 may configure a protecting time or a frequency domain gap around the SA-SS to reduce inter-subcarrier and inter-symbol interferences with communication OFDM symbols. For example, the wireless device 1102 may configure a protecting gap of one subcarrier in a frequency domain or one OFDM symbol in a time domain. The wireless device 1102 may be configured to not map data and/or reference signals to the resources used by the set of SA-SSs 1122 and its surrounding protective gaps to minimize interference.

At 1116, the wireless device 1102 may configure the sensing and communication signals for communicating with the wireless device 1106, and for performing sensing on the sensing area that the target object 1104 is within with the wireless device 1106. The wireless device 1102 may use an integrated ISAC waveform for simultaneous communication and sensing. The wireless device 1102 may distribute the sensing subcarriers in an OFDM symbol in a frequency domain, while using the other subcarriers for communication. Thus, while the set of communication signals 1120 and the set of sensing signals 1128 are shown in the communication flow diagram 1100 as separate transmissions, it should be understood that the set of communication signals 1120 and the set of sensing signals 1128 may be transmitted in an integrated ISAC OFDM waveform for simultaneous communication and sensing be distributing sensing subcarriers in an OFDM symbol having communication subcarriers. The wireless device 1102 may transmit each of the set of SA-SSs 1122 before transmitting the set of sensing signals 1128 by a length of the SA-SS gap configured at 1114.

The wireless device 1102 may transmit a set of configuration messages 1118 to the wireless device 1106. The wireless device 1106 may receive the set of configuration messages 1118 from the wireless device 1102. The set of configuration messages 1118 may include an indicator of the SA-SS configured gap. The set of configuration messages 1118 may include an indicator of a searching time scope associated with the set of SA-SSs 1122. For example, the set of configuration messages 1118 may include an indicator of the calculated

$${τ}_{s}^{min}$$

and an indicator of the calculated

$${τ}_{s}^{max} .$$

The set of configuration messages 1118 may include an indicator of an OFDM symbol

$${i}_{s}^{min}$$

that is correlated with the calculated

$${τ}_{s}^{min} ,$$

and an indicator of an OFDM symbol

$${i}_{s}^{max}$$

that is correlated with the calculated

$${τ}_{s}^{max} .$$

In some aspects, the set of configuration messages 1118 may include at least one of an RRC message, a MAC-CE, or DCI. For example, an RRC message may include a set of potential propagation delay values, and a MAC-CE or DCI may include an index to the set of propagation delay values. The set of configuration messages 1118 may include an indicator of a direction of the set of SA-SSs 1122. In some aspects, the direction of the set of SA-SSs 1122 may be the same as the direction of the set of sensing signals 1128, allowing for the wireless device 1106 to know the direction of both the direction of the set of SA-SSs 1122 and the direction of the set of sensing signals 1128 via a single indicator. The set of configuration messages 1118 may include an indicator of the bandwidth of the set of SA-SSs 1122. The set of configuration messages 1118 may include an indicator of a transmission power used by the wireless device 1102 to transmit the set of SA-SSs 1122. In some aspects, the wireless device 1106 may derive the transmission power of the set of SA-SSs from other attributes of the set of SA-SSs. For example, the transmission power for the set of SA-SSs may be calculated based on the difference of sensitivity between the set of SA-SSs 1122 and the set of sensing signals 1128 and the transmission power of the set of sensing signals 1128. The set of configuration messages 1118 may include a time domain sequence for the set of SA-SSs 1122. The set of configuration messages 1118 may include an indicator of a frequency domain sequence for the set of SA-SSs 1122. The set of configuration messages 1118 may include an indicator of a frequency domain position associated with the set of SA-SSs 1122. The set of configuration messages 1118 may include an indicator of a periodic schedule for the set of SA-SSs 1122 or an indicator of a transmission time for the set of SA-SSs 1122.

The wireless device 1102 may transmit the set of communication signals 1120 to the wireless device 1106. The wireless device 1106 may receive the set of communication signals 1120 from the wireless device 1102. The wireless device 1102 may transmit the set of SA-SSs 1122 at the sensing area that the target object 1104 is in. The set of SA-SSs 1122 may reflect off of the target object 1104 as the set of reflected SA-SSs 1124. The wireless device 1106 may receive the set of reflected SA-SSs 1124 from the target object 1104. After transmitting each of the set of SA-SSs 1122, the wireless device 1102 may transmit the set of sensing signals 1128 at the sensing area that the target object 1104 is in. The set of sensing signals 1128 may reflect off of the target object 1104 as the set of reflected sensing signals 1130. The wireless device 1106 may receive the set of reflected sensing signals 1130 from the target object 1104. The wireless device 1102 may transmit the set of communication signals 1120, the set of SA-SSs 1122, and the set of sensing signals 1128 as an integrated ISAC waveform for simultaneous communication and sensing.

At 1126, the wireless device 1106 may monitor for the set of reflected SA-SSs 1124 based on the set of configuration messages 1118. In some aspects, the wireless device 1106 may be configured to calculate when the set of reflected SA-SSs will arrive based on the set of configuration messages 1118. In some aspects, the wireless device 1106 may be configured to periodically monitor for the set of reflected SA-SSs 1124 based on a plurality of sliding windows, as shown in FIG. 10. In some aspects, the wireless device 1106 may accept a sliding window as being sufficient to receive one of the set of reflected SA-SSs when a calculated correlation result (e.g., a correlation coefficient) is larger than a threshold amount (e.g., 90%). The wireless device 1106 may calculate when the set of reflected sensing signals 1130 will arrive at the wireless device 1106 based on when the set of reflected SA-SSs 1124 are received.

At 1132, the wireless device 1106 may measure the set of reflected sensing signals 1130. At 1134, the wireless device 1106 may calculate a location of the target object 1104. At 1136, the wireless device 1106 may output the calculated location of the target object 1104. For example, the wireless device 1106 may transmit the calculated location of the target object in a report message that is transmitted to another wireless device, such as the wireless device 1102 or a component of a core network, such as an LMF. In another example, the wireless device 1106 may output the calculated location of the target object to a component of the wireless device 1106, which may save the calculated location to a memory, such as a drive or a cache, of the wireless device 1106.

At 1138, the wireless device 1106 may process the set of communication signals 1120. For example, the wireless device 1106 may decode the set of communication signals 1120 and follow a set of instructions in according to the decoded signals. While the communication flow diagram 1100 illustrates that the wireless device 1106 may process the set of communication signals 1120 at 1138 after monitoring for the set of reflected sensing signals 1130 at 1126, the wireless device 1106 may process the set of communication signals 1120 at 1138 before monitoring for the set of reflected sensing signals 1130 at 1126, or may perform both concurrently.

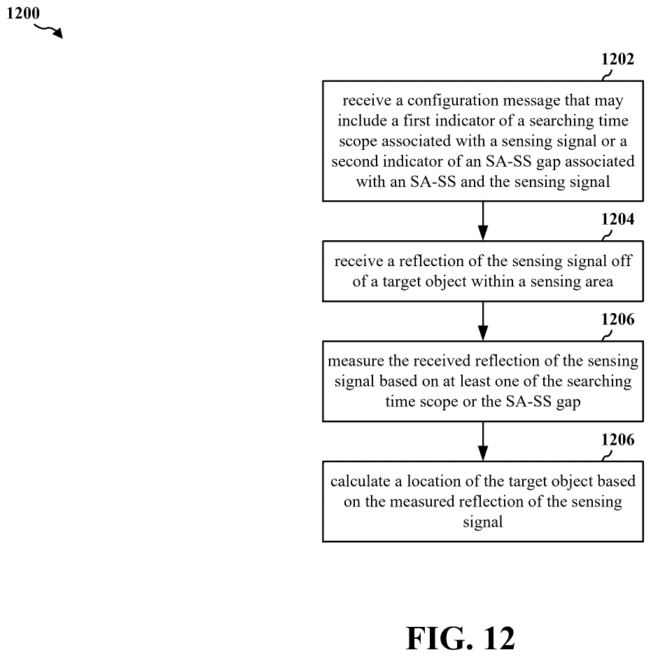

FIG. 12 is a flowchart 1200 of a method of wireless communication. The method may be performed by a wireless device (e.g., the UE 104, the UE 350; the base station 102, the base station 310; the wireless device 402, the wireless device 404, the wireless device 406, the wireless device 408, the wireless device 506, the wireless device 656, the wireless device 806, the wireless device 1106; the apparatus 1404; the network entity 1402, the network entity 1502, the network entity 1660). At 1202, the wireless device may receive a configuration message that may include a first indicator of a searching time scope associated with a sensing signal or a second indicator of a SA-SS gap associated with a SA-SS and the sensing signal. For example, 1202 may be performed by the wireless device 806 in FIG. 8, which may receive the set of configuration messages 818 from the wireless device 802. The set of configuration messages 818 may include a first indicator of a searching time scope associated with the set of sensing signals 828. In another example, 1202 may be performed by the wireless device 1106 in FIG. 11, which may receive the set of configuration messages 1118 from the wireless device 1102. The set of configuration messages 1118 may include a second indicator of a SA-SS gap associated with the set of SA-SSs 1122 and the set of sensing signals 1128. Moreover, 1202 may be performed by the component 198 in FIG. 1, 3, 14, 15, or 16.

At 1204, the wireless device may receive a reflection of the sensing signal off of a target object within a sensing area. For example, 1204 may be performed by the wireless device 806 in FIG. 8, which may receive the set of reflected sensing signals 830 off of the target object 804. The target object 804 may be within a sensing area. In another example, 1204 may be performed by the wireless device 1106 in FIG. 11, which may receive the set of reflected sensing signals 1130 off of the target object 1104. The target object 1104 may be within a sensing area. Moreover, 1204 may be performed by the component 198 in FIG. 1, 3, 14, 15, or 16.

At 1206, the wireless device may measure the received reflection of the sensing signal based on at least one of the searching time scope or the SA-SS gap. For example, 1206 may be performed by the wireless device 806 in FIG. 8, which may, at 832, measure the set of reflected sensing signals 830 based on the searching time scope. In another example, 1206 may be performed by the wireless device 1106 in FIG. 11, which may, at 1132, measure the set of reflected sensing signals 1130 based on SA-SS gap. Moreover, 1206 may be performed by the component 198 in FIG. 1, 3, 14, 15, or 16.

At 1208, the wireless device may calculate a location of the target object based on the measured reflection of the sensing signal. For example, 1208 may be performed by the wireless device 806 in FIG. 8, which may, at 834, calculate a location of the target object 804 based on the measurements taken at 832. In another example, 1208 may be performed by the wireless device 1106 in FIG. 11, which may, at 1134, calculate a location of the target object 1104 based on the measurements taken at 1132. Moreover, 1208 may be performed by the component 198 in FIG. 1, 3, 14, 15, or 16.

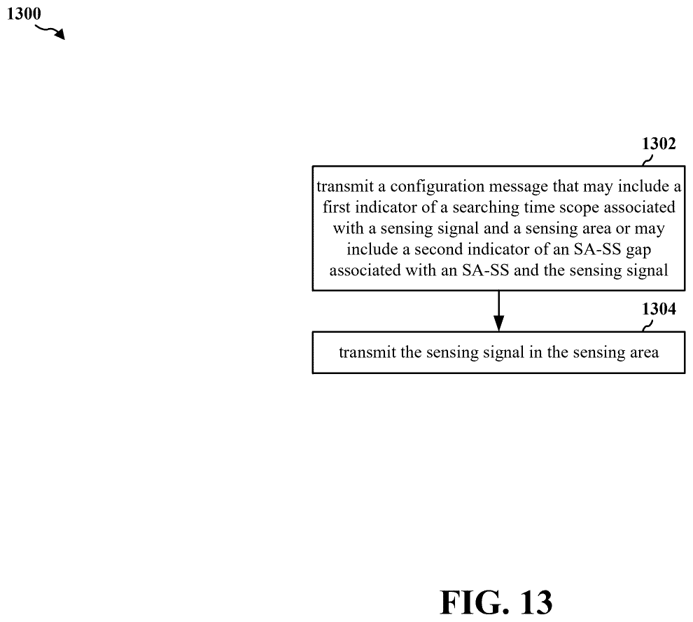

FIG. 13 is a flowchart 1300 of a method of wireless communication. The method may be performed by a wireless device (e.g., the UE 104, the UE 350; the base station 102, the base station 310; the wireless device 402, the wireless device 404, the wireless device 406, the wireless device 408, the wireless device 502, the wireless device 652, the wireless device 802, the wireless device 1102; the apparatus 1404; the network entity 1402, the network entity 1502, the network entity 1660). At 1302, the wireless device may transmit a configuration message that may include a first indicator of a searching time scope associated with a sensing signal and a sensing area or may include a second indicator of a SA-SS gap associated with a SA-SS and the sensing signal. For example, 1302 may be performed by the wireless device 802 in FIG. 8, which may transmit the set of configuration messages 818. The set of configuration messages 818 may include a first indicator of a searching time scope associated with the set of sensing signals 828 and a sensing area of the target object 804. In another example, 1302 may be performed by the wireless device 1102 in FIG. 11, which may transmit the set of configuration messages 1118. The set of configuration messages 1118 may include a second indicator of a SA-SS gap associated with the set of SA-SSs 1122 and the set of sensing signals 1128. Moreover, 1302 may be performed by the component 199 in FIG. 1, 3, 14, 15, or 16.

At 1304, the wireless device may transmit the sensing signal in the sensing area. For example, 1304 may be performed by the wireless device 802 in FIG. 8, which may transmit the set of sensing signals 828 in the sensing area of the target object 804. In another example, 1304 may be performed by the wireless device 1102 in FIG. 11, which may transmit the set of sensing signals 1128 in the sensing area of the target object 1104. Moreover, 1304 may be performed by the component 199 in FIG. 1, 3, 14, 15, or 16.

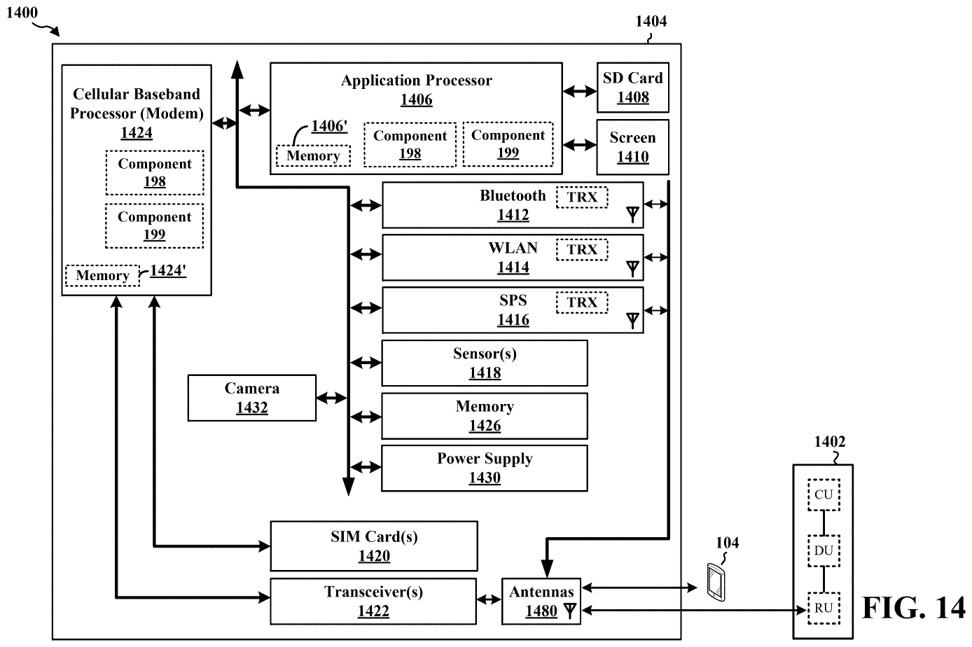

FIG. 14 is a diagram 1400 illustrating an example of a hardware implementation for an apparatus 1404. The apparatus 1404 may be a UE, a component of a UE, or may implement UE functionality. In some aspects, the apparatus 1404 may include at least one cellular baseband processor 1424 (also referred to as a modem) coupled to one or more transceivers 1422 (e.g., cellular RF transceiver). The cellular baseband processor(s) 1424 may include at least one on-chip memory 1424′. In some aspects, the apparatus 1404 may further include one or more subscriber identity modules (SIM) cards 1420 and at least one application processor 1406 coupled to a secure digital (SD) card 1408 and a screen 1410. The application processor(s) 1406 may include on-chip memory 1406′. In some aspects, the apparatus 1404 may further include a Bluetooth module 1412, a WLAN module 1414, an SPS module 1416 (e.g., GNSS module), one or more sensor modules 1418 (e.g., barometric pressure sensor/altimeter; motion sensor such as inertial measurement unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 1426, a power supply 1430, and/or a camera 1432. The Bluetooth module 1412, the WLAN module 1414, and the SPS module 1416 may include an on-chip transceiver (TRX) (or in some cases, just a receiver (RX)). The Bluetooth module 1412, the WLAN module 1414, and the SPS module 1416 may include their own dedicated antennas and/or utilize the antennas 1480 for communication. The cellular baseband processor(s) 1424 communicates through the transceiver(s) 1422 via one or more antennas 1480 with the UE 104 and/or with an RU associated with a network entity 1402. The cellular baseband processor(s) 1424 and the application processor(s) 1406 may each include a computer-readable medium/memory 1424′, 1406′, respectively. The additional memory modules 1426 may also be considered a computer-readable medium/memory. Each computer-readable medium/memory 1424′, 1406′, 1426 may be non-transitory. The cellular baseband processor(s) 1424 and the application processor(s) 1406 are each responsible for general processing, including the execution of software stored on the computer-readable medium/memory. The software, when executed by the cellular baseband processor(s) 1424/application processor(s) 1406, causes the cellular baseband processor(s) 1424/application processor(s) 1406 to perform the various functions described supra. The computer-readable medium/memory may also be used for storing data that is manipulated by the cellular baseband processor(s) 1424/application processor(s) 1406 when executing software. The cellular baseband processor(s) 1424/application processor(s) 1406 may be a component of the UE 350 and may include the at least one memory 360 and/or at least one of the TX processor 368, the RX processor 356, and the controller/processor 359. In one configuration, the apparatus 1404 may be at least one processor chip (modem and/or application) and include just the cellular baseband processor(s) 1424 and/or the application processor(s) 1406, and in another configuration, the apparatus 1404 may be the entire UE (e.g., see UE 350 of FIG. 3) and include the additional modules of the apparatus 1404.

As discussed supra, the component 198 may be configured to receive a configuration message. The configuration message may include a first indicator of a searching time scope associated with a sensing signal or a second indicator of a SA-SS gap associated with a SA-SS and the sensing signal. The component 198 may be configured to receive a reflection of the sensing signal off of a target object within a sensing area. The component 198 may be configured to measure the received reflection of the sensing signal based on at least one of the searching time scope or the SA-SS gap. The component 198 may be configured to calculate a location of the target object based on the measured reflection of the sensing signal. The component 198 may be configured to output a third indicator of the calculated location of the target object. The component 198 may be configured to output the third indicator by transmitting a report message including a third indicator of the calculated location of the target object or by storing the third indicator of the calculated location of the target object. The component 198 may be within the cellular baseband processor(s) 1424, the application processor(s) 1406, or both the cellular baseband processor(s) 1424 and the application processor(s) 1406. The component 198 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. As shown, the apparatus 1404 may include a variety of components configured for various functions. In one configuration, the apparatus 1404, and in particular the cellular baseband processor(s) 1424 and/or the application processor(s) 1406, may include means for receiving a configuration message. The configuration message may include a first indicator of a searching time scope associated with a sensing signal. The configuration message may include a second indicator of an SA-SS gap associated with a SA-SS and the sensing signal. The apparatus 1404 may include a means for receiving a reflection of the sensing signal off of a target object within a sensing area. The apparatus 1404 may include a means for measuring the received reflection of the sensing signal based on at least one of the searching time scope or the SA-SS gap. The apparatus 1404 may include a means for calculating a location of the target object based on the measured reflection of the sensing signal. The searching time scope may include a third indicator of a minimum sensing signal propagation delay associated with the reflection of the sensing signal and the sensing area. The searching time scope may include a fourth indicator of a maximum sensing signal propagation delay associated with the reflection of the sensing signal and the sensing area. The third indicator may include a first OFDM symbol index that corresponds with the minimum sensing signal propagation delay. The fourth indicator may include a second OFDM symbol index that corresponds with the maximum sensing signal propagation delay. For example, the OFDM symbol may correspond with the time occasion corresponding to the

$${τ}_{s}^{min}$$

or

$${τ}_{s}^{max}$$

to the start time of receiving the OFDM symbol in which the sensing signal is transmitted. The apparatus 1404 may include a means for outputting the indication of the calculated location of the target object by transmitting a report message including a third indicator of the calculated location of the target object or by storing the indication of the calculated location of the target object. The apparatus 1404 may include a means for receiving the reflection of the sensing signal off of the target object (1) by calculating a first point in time based on at least one of the minimum sensing signal propagation delay or the maximum sensing signal propagation delay, (2) by calculating a second point in time based on at least one of the minimum sensing signal propagation delay or the maximum sensing signal propagation delay and (3) by monitoring for the reflection of the sensing signal between the first point in time and the second point in time. The apparatus 1404 may include a means for monitoring for a reflection of a sensing signal by using a configuration to receive a reflection of the sensing signal during a time frame, such as using a fixed window indicated by the configuration to demodulate a sensing signal, or using a set of shifting windows starting at a fixed time frame indicated by the configuration to demodulate a sensing signal. The apparatus 1404 may include a means for calculating the first point in time based on at least one of the minimum sensing signal propagation delay or the maximum sensing signal propagation delay (1) by calculating the first point in time based on a T_{CP} of the sensing signal in response to the T_{CP} of the sensing signal being greater than or equal to the maximum sensing signal propagation delay, (2) by calculating the first point in time based on the T_{CP} of the sensing signal in response to the T_{CP} of the sensing signal being less than the maximum sensing signal propagation delay and greater than or equal to the minimum sensing signal propagation delay, or (3) by calculating the first point in time based on the minimum sensing signal propagation delay in response to the T_{CP} of the sensing signal being less than the minimum sensing signal propagation delay. The apparatus 1404 may include a means for calculating the second point in time based on at least one of the minimum sensing signal propagation delay or the maximum sensing signal propagation delay (1) by calculating the second point in time based on a T_{CP} of the sensing signal and a time length of the sensing signal in response to the T_{CP} of the sensing signal being greater than or equal to the maximum sensing signal propagation delay, (2) by calculating the second point in time based on the maximum sensing signal propagation delay and the time length of the sensing signal in response to the T_{CP} of the sensing signal being less than the maximum sensing signal propagation delay and greater than or equal to the minimum sensing signal propagation delay, or (3) by calculating the second point in time based on the maximum sensing signal propagation delay and the time length of the sensing signal in response to the T_{CP} of the sensing signal being less than the minimum sensing signal propagation delay. The apparatus 1404 may include a means for receiving a second reflection of the SA-SS off of the target object before receiving the reflection of the sensing signal off of the target object. The apparatus 1404 may include a means for receiving the reflection of the sensing signal off of the target object by calculating a termination time corresponding with when the reception of the second reflection of the SA-SS terminates and by monitoring for the reflection of the sensing signal based on the calculated termination time and the SA-SS gap. The apparatus 1404 may include a means for receiving the second reflection of the SA-SS off of the target object by periodically monitoring for the second reflection of the SA-SS off of the target object based on a plurality of sliding windows and by selecting a sliding window from the plurality of sliding windows based on a correlation coefficient associated with the selected sliding window being greater or equal to a threshold amount. The calculated termination time may be based on the selected sliding window. The apparatus 1404 may include a means for receiving a set of configuration messages including a SA-SS configuration of the SA-SS. The apparatus 1404 may include a means for calculating a processing latency based on the SA-SS configuration. The apparatus 1404 may include a means for transmitting a processing capability message including a third indicator of the calculated processing latency before the reception of the configuration message. The SA-SS gap may be greater than or equal to the calculated processing latency. The SA-SS configuration may include at least one of (1) a fourth indicator of a first direction of the SA-SS, where the first direction of the SA-SS and a second direction of the sensing signal is a same direction, (2) a fifth indicator of a bandwidth of the SA-SS, (3) a sixth indicator of a transmission power associated with the SA-SS, (4) a seventh indicator of a time domain sequence associated with the SA-SS, (5) an eighth indictor of a frequency domain sequence associated with the SA-SS, or (6) a ninth indicator of a frequency domain position associated with the SA-SS. The set of configuration messages may include at least one of an RRC message, a MAC-CE, or DCI. The SA-SS configuration may include a fourth indicator of a second searching time scope associated with the SA-SS. The second searching time scope may include a fifth indicator of a minimum SA-SS propagation delay associated with the second reflection of the SA-SS and a sixth indicator of a maximum SA-SS propagation delay associated with the second reflection of the SA-SS. The fifth indicator may include a first OFDM symbol index that corresponds with the minimum SA-SS propagation delay. The sixth indicator may include a second OFDM symbol index that corresponds with the maximum SA-SS propagation delay. The apparatus 1404 may include a means for receiving the second reflection of the SA-SS off of the target object (1) by calculating a first point in time based on at least one of the minimum SA-SS propagation delay or the maximum SA-SS propagation delay, (2) by calculating a second point in time based on at least one of the minimum SA-SS propagation delay or the maximum SA-SS propagation delay, and (3) by monitoring for the second reflection of the SA-SS between the first point in time and the second point in time. The apparatus 1404 may include a means for calculating the first point in time based on at least one of the minimum SA-SS propagation delay or the maximum SA-SS propagation delay may include at least one of: (1) calculating the first point in time based on a T_{CP} of the SA-SS in response to the T_{CP} of the SA-SS being greater than or equal to the maximum SA-SS propagation delay, (2) calculating the first point in time based on the T_{CP} of the SA-SS in response to the T_{CP} of the SA-SS being less than the maximum SA-SS propagation delay and greater than or equal to the minimum SA-SS propagation delay, or (3) calculating the first point in time based on the minimum SA-SS propagation delay in response to the T_{CP} of the SA-SS being less than the minimum SA-SS propagation delay. The apparatus 1404 may include a means for calculating the second point in time based on at least one of the minimum SA-SS propagation delay or the maximum SA-SS propagation delay may include at least one of (1) calculating the second point in time based on a T_{CP} of the SA-SS and a time length of the SA-SS in response to the T_{CP} of the SA-SS being greater than or equal to the maximum SA-SS propagation delay, (2) calculating the second point in time based on the maximum SA-SS propagation delay and the time length of the SA-SS in response to the T_{CP} of the SA-SS being less than the maximum SA-SS propagation delay and greater than or equal to the minimum SA-SS propagation delay, and (3) calculating the second point in time based on the maximum SA-SS propagation delay and the time length of the SA-SS in response to the T_{CP} of the SA-SS being less than the minimum SA-SS propagation delay. The apparatus 1404 may include a UE. The means may be the component 198 of the apparatus 1404 configured to perform the functions recited by the means. As described supra, the apparatus 1404 may include the TX processor 368, the RX processor 356, and the controller/processor 359. As such, in one configuration, the means may be the TX processor 368, the RX processor 356, and/or the controller/processor 359 configured to perform the functions recited by the means.

As discussed supra, the component 199 may be configured to transmit a configuration message. The configuration message may include a first indicator of a searching time scope associated with a sensing signal. The configuration message may include a second indicator of an SA-SS gap associated with a SA-SS and the sensing signal. The component 199 may be configured to transmit the sensing signal in the sensing area. The sensing signal configuration component 199 may be configured to receive a report message. The report message may include a third indicator of a location of a target object within the sensing area calculated based on the configuration message. The component 199 may be within the cellular baseband processor(s) 1424, the application processor(s) 1406, or both the cellular baseband processor(s) 1424 and the application processor(s) 1406. The component 199 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. As shown, the apparatus 1404 may include a variety of components configured for various functions. In one configuration, the apparatus 1404, and in particular the cellular baseband processor(s) 1424 and/or the application processor(s) 1406, may include means for transmitting a configuration message. The configuration message may include a first indicator of a searching time scope associated with a sensing signal. The configuration message may include a second indicator of an SA-SS gap associated with a SA-SS and the sensing signal. The apparatus 1404 may include means for transmitting the sensing signal in the sensing area. The apparatus 1404 may include means for receiving a report message including a third indicator of a location of a target object within the sensing area calculated based on the configuration message. The apparatus 1404 may include means for calculating a minimum sensing signal propagation delay and a maximum sensing signal propagation delay based on the sensing area. The searching time scope may include a third indicator of the calculated minimum sensing signal propagation delay associated with a reflection of the sensing signal off of a target object within the sensing area. The searching time scope may include a fourth indicator of the calculated maximum sensing signal propagation delay associated with the reflection of the sensing signal. The third indicator may include a first OFDM symbol index that corresponds with the minimum sensing signal propagation delay. The fourth indicator may include a second OFDM symbol index that corresponds with the maximum sensing signal propagation delay. The apparatus 1404 may include means for transmitting the SA-SS in the sensing area before transmitting the sensing signal in the sensing area. The apparatus 1404 may include means for transmitting a set of configuration messages including a SA-SS configuration of the SA-SS. The apparatus 1404 may include means for receiving a processing capability message including a third indicator of a calculated processing latency before the transmission of the configuration message. The apparatus 1404 may include means for calculating the SA-SS gap based on the calculated processing latency. The SA-SS configuration may include at least one of (1) a fourth indicator of a first direction of the SA-SS, where the first direction of the SA-SS and a second direction of the sensing signal is a same direction, (2) a fifth indicator of a bandwidth of the SA-SS, (3) a sixth indicator of a transmission power associated with the SA-SS, (4) a seventh indicator of a time domain sequence associated with the SA-SS, (5) an eighth indictor of a frequency domain sequence associated with the SA-SS, or (6) a ninth indicator of a frequency domain position associated with the SA-SS. The set of configuration messages may include at least one of an RRC message, a MAC-CE, or DCI. The apparatus 1404 may include means for calculating a minimum SA-SS propagation delay and a maximum SA-SS propagation delay based on the sensing area. The SA-SS configuration may include a fourth indicator of a second searching time scope associated with the SA-SS. The searching time scope may include a fifth indicator of the calculated minimum SA-SS propagation delay associated with a reflection of the SA-SS off of a target object within the sensing area and a sixth indicator of the calculated maximum SA-SS propagation delay associated with the reflection of the SA-SS. The third indicator may include a first OFDM symbol index that corresponds with the minimum SA-SS propagation delay. The fourth indicator may include a second OFDM symbol index that corresponds with the maximum SA-SS propagation delay. The apparatus 1404 may include a UE. The means may be the component 199 of the apparatus 1404 configured to perform the functions recited by the means. As described supra, the apparatus 1404 may include the TX processor 368, the RX processor 356, and the controller/processor 359. As such, in one configuration, the means may be the TX processor 368, the RX processor 356, and/or the controller/processor 359 configured to perform the functions recited by the means.

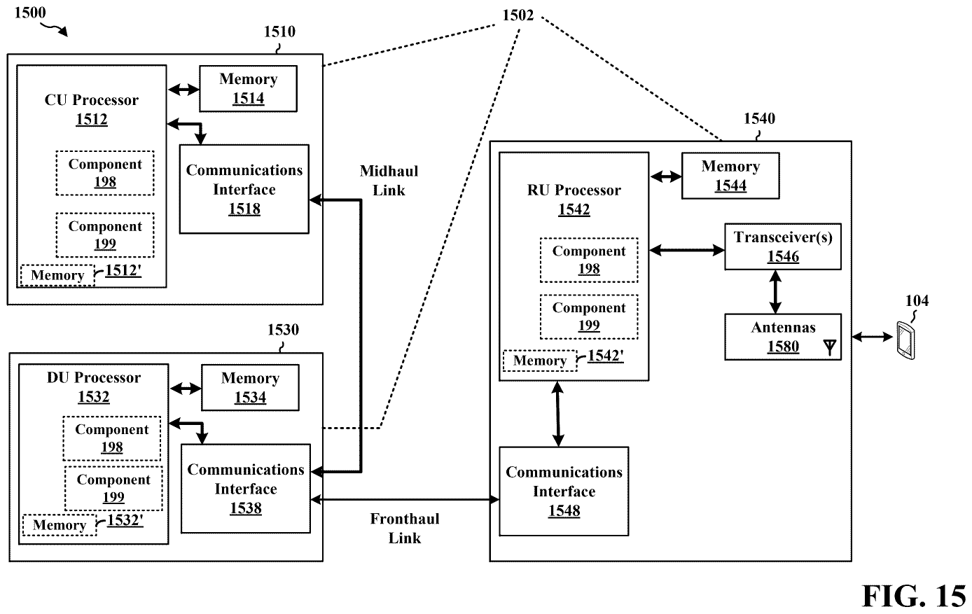

FIG. 15 is a diagram 1500 illustrating an example of a hardware implementation for a network entity 1502. The network entity 1502 may be a BS, a component of a BS, or may implement BS functionality. The network entity 1502 may include at least one of a CU 1510, a DU 1530, or an RU 1540. For example, depending on the layer functionality handled by the component 199, the network entity 1502 may include the CU 1510; both the CU 1510 and the DU 1530; each of the CU 1510, the DU 1530, and the RU 1540; the DU 1530; both the DU 1530 and the RU 1540; or the RU 1540. The CU 1510 may include at least one CU processor 1512. The CU processor(s) 1512 may include on-chip memory 1512′. In some aspects, the CU 1510 may further include additional memory modules 1514 and a communications interface 1518. The CU 1510 communicates with the DU 1530 through a midhaul link, such as an F1 interface. The DU 1530 may include at least one DU processor 1532. The DU processor(s) 1532 may include on-chip memory 1532′. In some aspects, the DU 1530 may further include additional memory modules 1534 and a communications interface 1538. The DU 1530 communicates with the RU 1540 through a fronthaul link. The RU 1540 may include at least one RU processor 1542. The RU processor(s) 1542 may include on-chip memory 1542′. In some aspects, the RU 1540 may further include additional memory modules 1544, one or more transceivers 1546, antennas 1580, and a communications interface 1548. The RU 1540 communicates with the UE 104. The on-chip memory 1512′, 1532′, 1542′ and the additional memory modules 1514, 1534, 1544 may each be considered a computer-readable medium/memory. Each computer-readable medium/memory may be non-transitory. Each of the processors 1512, 1532, 1542 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, the component 198 may be configured to receive a configuration message. The configuration message may include a first indicator of a searching time scope associated with a sensing signal. The configuration message may include a second indicator of an SA-SS gap associated with a SA-SS and the sensing signal. The component 198 may be configured to receive a reflection of the sensing signal off of a target object within a sensing area. The component 198 may be configured to measure the received reflection of the sensing signal based on at least one of the searching time scope or the SA-SS gap. The component 198 may be configured to calculate a location of the target object based on the measured reflection of the sensing signal. The component 198 may be configured to output a third indicator of the calculated location of the target object. The component 198 may be configured to output the third indicator by transmitting a report message including a third indicator of the calculated location of the target object or by storing the third indicator of the calculated location of the target object. The component 198 may be within one or more processors of one or more of the CU 1510, DU 1530, and the RU 1540. The component 198 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. The network entity 1502 may include a variety of components configured for various functions. In one configuration, the network entity 1502 may include means for receiving a configuration message. The configuration message may include a first indicator of a searching time scope associated with a sensing signal. The configuration message may include a second indicator of an SA-SS gap associated with a SA-SS and the sensing signal. The network entity 1502 may include a means for receiving a reflection of the sensing signal off of a target object within a sensing area. The network entity 1502 may include a means for measuring the received reflection of the sensing signal based on at least one of the searching time scope or the SA-SS gap. The network entity 1502 may include a means for calculating a location of the target object based on the measured reflection of the sensing signal. The searching time scope may include a third indicator of a minimum sensing signal propagation delay associated with the reflection of the sensing signal and the sensing area. The searching time scope may include a fourth indicator of a maximum sensing signal propagation delay associated with the reflection of the sensing signal and the sensing area. The third indicator may include a first OFDM symbol index that corresponds with the minimum sensing signal propagation delay. The fourth indicator may include a second OFDM symbol index that corresponds with the maximum sensing signal propagation delay. For example, the OFDM symbol may correspond with the time occasion corresponding to the

$${τ}_{s}^{min}$$

or

$${τ}_{s}^{max}$$

value relative to the start time of receiving the OFDM symbol in which the sensing signal may be transmitted. The network entity 1502 may include a means for outputting the indication of the calculated location of the target object by transmitting a report message including a third indicator of the calculated location of the target object or by storing the indication of the calculated location of the target object. The network entity 1502 may include a means for receiving the reflection of the sensing signal off of the target object (1) by calculating a first point in time based on at least one of the minimum sensing signal propagation delay or the maximum sensing signal propagation delay, (2) by calculating a second point in time based on at least one of the minimum sensing signal propagation delay or the maximum sensing signal propagation delay and (3) by monitoring for the reflection of the sensing signal between the first point in time and the second point in time. The network entity 1502 may include a means for monitoring for a reflection of a sensing signal by using a configuration to receive a reflection of the sensing signal during a time frame, such as using a fixed window indicated by the configuration to demodulate a sensing signal, or using a set of shifting windows starting at a fixed time frame indicated by the configuration to demodulate a sensing signal. The network entity 1502 may include a means for calculating the first point in time based on at least one of the minimum sensing signal propagation delay or the maximum sensing signal propagation delay (1) by calculating the first point in time based on a T_{CP} of the sensing signal in response to the T_{CP} of the sensing signal being greater than or equal to the maximum sensing signal propagation delay, (2) by calculating the first point in time based on the T_{CP} of the sensing signal in response to the T_{CP} of the sensing signal being less than the maximum sensing signal propagation delay and greater than or equal to the minimum sensing signal propagation delay, or (3) by calculating the first point in time based on the minimum sensing signal propagation delay in response to the T_{CP} of the sensing signal being less than the minimum sensing signal propagation delay. The network entity 1502 may include a means for calculating the second point in time based on at least one of the minimum sensing signal propagation delay or the maximum sensing signal propagation delay (1) by calculating the second point in time based on a T_{CP} of the sensing signal and a time length of the sensing signal in response to the T_{CP} of the sensing signal being greater than or equal to the maximum sensing signal propagation delay, (2) by calculating the second point in time based on the maximum sensing signal propagation delay and the time length of the sensing signal in response to the T_{CP} of the sensing signal being less than the maximum sensing signal propagation delay and greater than or equal to the minimum sensing signal propagation delay, or (3) by calculating the second point in time based on the maximum sensing signal propagation delay and the time length of the sensing signal in response to the T_{CP} of the sensing signal being less than the minimum sensing signal propagation delay. The network entity 1502 may include a means for receiving a second reflection of the SA-SS off of the target object before receiving the reflection of the sensing signal off of the target object. The network entity 1502 may include a means for receiving the reflection of the sensing signal off of the target object by calculating a termination time corresponding with when the reception of the second reflection of the SA-SS terminates and by monitoring for the reflection of the sensing signal based on the calculated termination time and the SA-SS gap. The network entity 1502 may include a means for receiving the second reflection of the SA-SS off of the target object by periodically monitoring for the second reflection of the SA-SS off of the target object based on a plurality of sliding windows and by selecting a sliding window from the plurality of sliding windows based on a correlation coefficient associated with the selected sliding window being greater or equal to a threshold amount. The calculated termination time may be based on the selected sliding window. The network entity 1502 may include a means for receiving a set of configuration messages including a SA-SS configuration of the SA-SS. The network entity 1502 may include a means for calculating a processing latency based on the SA-SS configuration. The network entity 1502 may include a means for transmitting a processing capability message including a third indicator of the calculated processing latency before the reception of the configuration message. The SA-SS gap may be greater than or equal to the calculated processing latency. The SA-SS configuration may include at least one of (1) a fourth indicator of a first direction of the SA-SS, where the first direction of the SA-SS and a second direction of the sensing signal is a same direction, (2) a fifth indicator of a bandwidth of the SA-SS, (3) a sixth indicator of a transmission power associated with the SA-SS, (4) a seventh indicator of a time domain sequence associated with the SA-SS, (5) an eighth indictor of a frequency domain sequence associated with the SA-SS, or (6) a ninth indicator of a frequency domain position associated with the SA-SS. The set of configuration messages may include at least one of an RRC message, a MAC-CE, or DCI. The SA-SS configuration may include a fourth indicator of a second searching time scope associated with the SA-SS. The second searching time scope may include a fifth indicator of a minimum SA-SS propagation delay associated with the second reflection of the SA-SS and a sixth indicator of a maximum SA-SS propagation delay associated with the second reflection of the SA-SS. The fifth indicator may include a first OFDM symbol index that corresponds with the minimum SA-SS propagation delay. The sixth indicator may include a second OFDM symbol index that corresponds with the maximum SA-SS propagation delay. The network entity 1502 may include a means for receiving the second reflection of the SA-SS off of the target object (1) by calculating a first point in time based on at least one of the minimum SA-SS propagation delay or the maximum SA-SS propagation delay, (2) by calculating a second point in time based on at least one of the minimum SA-SS propagation delay or the maximum SA-SS propagation delay, and (3) by monitoring for the second reflection of the SA-SS between the first point in time and the second point in time. The network entity 1502 may include a means for calculating the first point in time based on at least one of the minimum SA-SS propagation delay or the maximum SA-SS propagation delay may include at least one of: (1) calculating the first point in time based on a T_{CP} of the SA-SS in response to the T_{CP} of the SA-SS being greater than or equal to the maximum SA-SS propagation delay, (2) calculating the first point in time based on the T_{CP} of the SA-SS in response to the T_{CP} of the SA-SS being less than the maximum SA-SS propagation delay and greater than or equal to the minimum SA-SS propagation delay, or (3) calculating the first point in time based on the minimum SA-SS propagation delay in response to the T_{CP} of the SA-SS being less than the minimum SA-SS propagation delay. The network entity 1502 may include a means for calculating the second point in time based on at least one of the minimum SA-SS propagation delay or the maximum SA-SS propagation delay may include at least one of (1) calculating the second point in time based on a T_{CP} of the SA-SS and a time length of the SA-SS in response to the T_{CP} of the SA-SS being greater than or equal to the maximum SA-SS propagation delay, (2) calculating the second point in time based on the maximum SA-SS propagation delay and the time length of the SA-SS in response to the T_{CP} of the SA-SS being less than the maximum SA-SS propagation delay and greater than or equal to the minimum SA-SS propagation delay, and (3) calculating the second point in time based on the maximum SA-SS propagation delay and the time length of the SA-SS in response to the T_{CP} of the SA-SS being less than the minimum SA-SS propagation delay. The network entity 1502 may include a network node. The means may be the component 198 of the network entity 1502 configured to perform the functions recited by the means. As described supra, the network entity 1502 may include the TX processor 316, the RX processor 370, and the controller/processor 375. As such, in one configuration, the means may be the TX processor 316, the RX processor 370, and/or the controller/processor 375 configured to perform the functions recited by the means.

As discussed supra, the component 199 may be configured to transmit a configuration message. The configuration message may include a first indicator of a searching time scope associated with a sensing signal. The configuration message may include a second indicator of an SA-SS gap associated with a SA-SS and the sensing signal. The component 199 may be configured to transmit the sensing signal in the sensing area. The sensing signal configuration component 199 may be configured to receive a report message. The report message may include a third indicator of a location of a target object within the sensing area calculated based on the configuration message. The component 199 may be within one or more processors of one or more of the CU 1510, DU 1530, and the RU 1540. The component 199 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. The network entity 1502 may include a variety of components configured for various functions. In one configuration, the network entity 1502 may include means for transmitting a configuration message. The configuration message may include a first indicator of a searching time scope associated with a sensing signal. The configuration message may include a second indicator of an SA-SS gap associated with a SA-SS and the sensing signal. The network entity 1502 may include means for transmitting the sensing signal in the sensing area. The network entity 1502 may include means for receiving a report message including a third indicator of a location of a target object within the sensing area calculated based on the configuration message. The network entity 1502 may include means for calculating a minimum sensing signal propagation delay and a maximum sensing signal propagation delay based on the sensing area. The searching time scope may include a third indicator of the calculated minimum sensing signal propagation delay associated with a reflection of the sensing signal off of a target object within the sensing area. The searching time scope may include a fourth indicator of the calculated maximum sensing signal propagation delay associated with the reflection of the sensing signal. The third indicator may include a first OFDM symbol index that corresponds with the minimum sensing signal propagation delay. The fourth indicator may include a second OFDM symbol index that corresponds with the maximum sensing signal propagation delay. The network entity 1502 may include means for transmitting the SA-SS in the sensing area before transmitting the sensing signal in the sensing area. The network entity 1502 may include means for transmitting a set of configuration messages including a SA-SS configuration of the SA-SS. The network entity 1502 may include means for receiving a processing capability message including a third indicator of a calculated processing latency before the transmission of the configuration message. The network entity 1502 may include means for calculating the SA-SS gap based on the calculated processing latency. The SA-SS configuration may include at least one of (1) a fourth indicator of a first direction of the SA-SS, where the first direction of the SA-SS and a second direction of the sensing signal is a same direction, (2) a fifth indicator of a bandwidth of the SA-SS, (3) a sixth indicator of a transmission power associated with the SA-SS, (4) a seventh indicator of a time domain sequence associated with the SA-SS, (5) an eighth indictor of a frequency domain sequence associated with the SA-SS, or (6) a ninth indicator of a frequency domain position associated with the SA-SS. The set of configuration messages may include at least one of an RRC message, a MAC-CE, or DCI. The network entity 1502 may include means for calculating a minimum SA-SS propagation delay and a maximum SA-SS propagation delay based on the sensing area. The SA-SS configuration may include a fourth indicator of a second searching time scope associated with the SA-SS. The searching time scope may include a fifth indicator of the calculated minimum SA-SS propagation delay associated with a reflection of the SA-SS off of a target object within the sensing area and a sixth indicator of the calculated maximum SA-SS propagation delay associated with the reflection of the SA-SS. The third indicator may include a first OFDM symbol index that corresponds with the minimum SA-SS propagation delay. The fourth indicator may include a second OFDM symbol index that corresponds with the maximum SA-SS propagation delay. The network entity 1502 may include a network node. The means may be the component 199 of the network entity 1502 configured to perform the functions recited by the means. As described supra, the network entity 1502 may include the TX processor 316, the RX processor 370, and the controller/processor 375. As such, in one configuration, the means may be the TX processor 316, the RX processor 370, and/or the controller/processor 375 configured to perform the functions recited by the means.

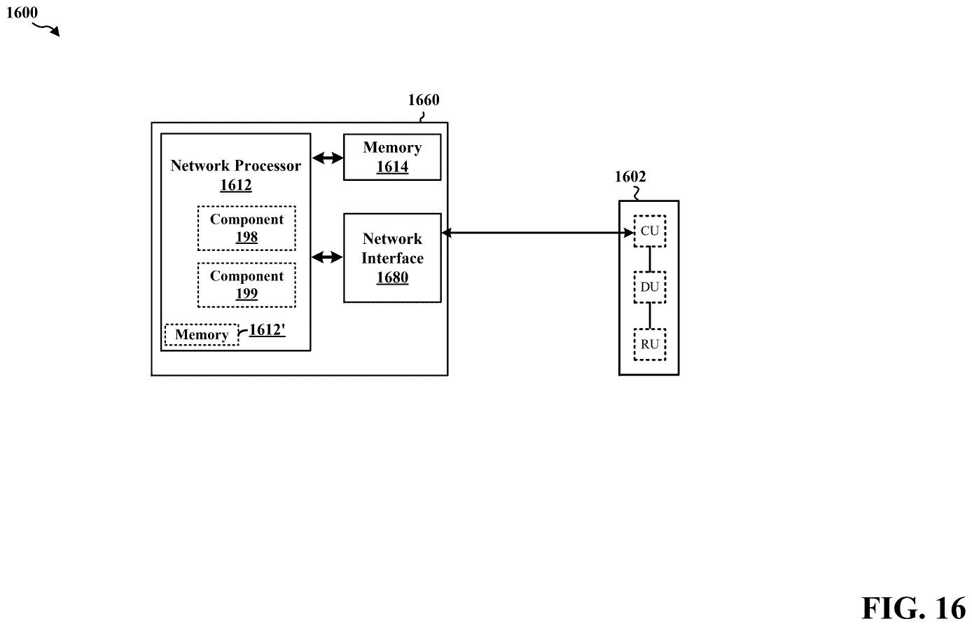

FIG. 16 is a diagram 1600 illustrating an example of a hardware implementation for a network entity 1660. In one example, the network entity 1660 may be within the core network 120. The network entity 1660 may include at least one network processor 1612. The network processor(s) 1612 may include on-chip memory 1612′. In some aspects, the network entity 1660 may further include additional memory modules 1614. The network entity 1660 communicates via the network interface 1680 directly (e.g., backhaul link) or indirectly (e.g., through a RIC) with the CU 1602. The on-chip memory 1612′ and the additional memory modules 1614 may each be considered a computer-readable medium/memory. Each computer-readable medium/memory may be non-transitory. The network processor(s) 1612 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, the component 198 may be configured to receive a configuration message. The configuration message may include a first indicator of a searching time scope associated with a sensing signal. The configuration message may include a second indicator of an SA-SS gap associated with a SA-SS and the sensing signal. The component 198 may be configured to receive a reflection of the sensing signal off of a target object within a sensing area. The component 198 may be configured to measure the received reflection of the sensing signal based on at least one of the searching time scope or the SA-SS gap. The component 198 may be configured to calculate a location of the target object based on the measured reflection of the sensing signal. The component 198 may be configured to output a third indicator of the calculated location of the target object. The component 198 may be configured to output the third indicator by transmitting a report message including a third indicator of the calculated location of the target object or by storing the third indicator of the calculated location of the target object. The component 198 may be within the network processor(s) 1612. The component 198 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. The network entity 1660 may include a variety of components configured for various functions. In one configuration, the network entity 1660 may include means for receiving a configuration message. The configuration message may include a first indicator of a searching time scope associated with a sensing signal. The configuration message may include a second indicator of an SA-SS gap associated with a SA-SS and the sensing signal. The network entity 1660 may include a means for receiving a reflection of the sensing signal off of a target object within a sensing area. The network entity 1660 may include a means for measuring the received reflection of the sensing signal based on at least one of the searching time scope or the SA-SS gap. The network entity 1660 may include a means for calculating a location of the target object based on the measured reflection of the sensing signal. The searching time scope may include a third indicator of a minimum sensing signal propagation delay associated with the reflection of the sensing signal and the sensing area. The searching time scope may include a fourth indicator of a maximum sensing signal propagation delay associated with the reflection of the sensing signal and the sensing area. The third indicator may include a first OFDM symbol index that corresponds with the minimum sensing signal propagation delay. The fourth indicator may include a second OFDM symbol index that corresponds with the maximum sensing signal propagation delay. For example, the OFDM symbol may correspond with the time occasion corresponding to the

$${τ}_{s}^{min}$$

or

$${τ}_{s}^{max}$$

value relative to the start time of receiving the OFDM symbol in which the sensing signal may be transmitted. The network entity 1660 may include a means for outputting the indication of the calculated location of the target object by transmitting a report message including a third indicator of the calculated location of the target object or by storing the indication of the calculated location of the target object. The network entity 1660 may include a means for receiving the reflection of the sensing signal off of the target object (1) by calculating a first point in time based on at least one of the minimum sensing signal propagation delay or the maximum sensing signal propagation delay, (2) by calculating a second point in time based on at least one of the minimum sensing signal propagation delay or the maximum sensing signal propagation delay and (3) by monitoring for the reflection of the sensing signal between the first point in time and the second point in time. The network entity 1660 may include a means for monitoring for a reflection of a sensing signal by using a configuration to receive a reflection of the sensing signal during a time frame, such as using a fixed window indicated by the configuration to demodulate a sensing signal, or using a set of shifting windows starting at a fixed time frame indicated by the configuration to demodulate a sensing signal. The network entity 1660 may include a means for calculating the first point in time based on at least one of the minimum sensing signal propagation delay or the maximum sensing signal propagation delay (1) by calculating the first point in time based on a T_{CP} of the sensing signal in response to the T_{CP} of the sensing signal being greater than or equal to the maximum sensing signal propagation delay, (2) by calculating the first point in time based on the T_{CP} of the sensing signal in response to the T_{CP} of the sensing signal being less than the maximum sensing signal propagation delay and greater than or equal to the minimum sensing signal propagation delay, or (3) by calculating the first point in time based on the minimum sensing signal propagation delay in response to the T_{CP} of the sensing signal being less than the minimum sensing signal propagation delay. The network entity 1660 may include a means for calculating the second point in time based on at least one of the minimum sensing signal propagation delay or the maximum sensing signal propagation delay (1) by calculating the second point in time based on a T_{CP} of the sensing signal and a time length of the sensing signal in response to the T_{CP} of the sensing signal being greater than or equal to the maximum sensing signal propagation delay, (2) by calculating the second point in time based on the maximum sensing signal propagation delay and the time length of the sensing signal in response to the T_{CP} of the sensing signal being less than the maximum sensing signal propagation delay and greater than or equal to the minimum sensing signal propagation delay, or (3) by calculating the second point in time based on the maximum sensing signal propagation delay and the time length of the sensing signal in response to the T_{CP} of the sensing signal being less than the minimum sensing signal propagation delay. The network entity 1660 may include a means for receiving a second reflection of the SA-SS off of the target object before receiving the reflection of the sensing signal off of the target object. The network entity 1660 may include a means for receiving the reflection of the sensing signal off of the target object by calculating a termination time corresponding with when the reception of the second reflection of the SA-SS terminates and by monitoring for the reflection of the sensing signal based on the calculated termination time and the SA-SS gap. The network entity 1660 may include a means for receiving the second reflection of the SA-SS off of the target object by periodically monitoring for the second reflection of the SA-SS off of the target object based on a plurality of sliding windows and by selecting a sliding window from the plurality of sliding windows based on a correlation coefficient associated with the selected sliding window being greater or equal to a threshold amount. The calculated termination time may be based on the selected sliding window. The network entity 1660 may include a means for receiving a set of configuration messages including a SA-SS configuration of the SA-SS. The network entity 1660 may include a means for calculating a processing latency based on the SA-SS configuration. The network entity 1660 may include a means for transmitting a processing capability message including a third indicator of the calculated processing latency before the reception of the configuration message. The SA-SS gap may be greater than or equal to the calculated processing latency. The SA-SS configuration may include at least one of (1) a fourth indicator of a first direction of the SA-SS, where the first direction of the SA-SS and a second direction of the sensing signal is a same direction, (2) a fifth indicator of a bandwidth of the SA-SS, (3) a sixth indicator of a transmission power associated with the SA-SS, (4) a seventh indicator of a time domain sequence associated with the SA-SS, (5) an eighth indictor of a frequency domain sequence associated with the SA-SS, or (6) a ninth indicator of a frequency domain position associated with the SA-SS. The set of configuration messages may include at least one of an RRC message, a MAC-CE, or DCI. The SA-SS configuration may include a fourth indicator of a second searching time scope associated with the SA-SS. The second searching time scope may include a fifth indicator of a minimum SA-SS propagation delay associated with the second reflection of the SA-SS and a sixth indicator of a maximum SA-SS propagation delay associated with the second reflection of the SA-SS. The fifth indicator may include a first OFDM symbol index that corresponds with the minimum SA-SS propagation delay. The sixth indicator may include a second OFDM symbol index that corresponds with the maximum SA-SS propagation delay. The network entity 1660 may include a means for receiving the second reflection of the SA-SS off of the target object (1) by calculating a first point in time based on at least one of the minimum SA-SS propagation delay or the maximum SA-SS propagation delay, (2) by calculating a second point in time based on at least one of the minimum SA-SS propagation delay or the maximum SA-SS propagation delay, and (3) by monitoring for the second reflection of the SA-SS between the first point in time and the second point in time. The network entity 1660 may include a means for calculating the first point in time based on at least one of the minimum SA-SS propagation delay or the maximum SA-SS propagation delay may include at least one of: (1) calculating the first point in time based on a T_{CP} of the SA-SS in response to the T_{CP} of the SA-SS being greater than or equal to the maximum SA-SS propagation delay, (2) calculating the first point in time based on the T_{CP} of the SA-SS in response to the T_{CP} of the SA-SS being less than the maximum SA-SS propagation delay and greater than or equal to the minimum SA-SS propagation delay, or (3) calculating the first point in time based on the minimum SA-SS propagation delay in response to the T_{CP} of the SA-SS being less than the minimum SA-SS propagation delay. The network entity 1660 may include a means for calculating the second point in time based on at least one of the minimum SA-SS propagation delay or the maximum SA-SS propagation delay may include at least one of (1) calculating the second point in time based on a T_{CP} of the SA-SS and a time length of the SA-SS in response to the T_{CP} of the SA-SS being greater than or equal to the maximum SA-SS propagation delay, (2) calculating the second point in time based on the maximum SA-SS propagation delay and the time length of the SA-SS in response to the T_{CP} of the SA-SS being less than the maximum SA-SS propagation delay and greater than or equal to the minimum SA-SS propagation delay, and (3) calculating the second point in time based on the maximum SA-SS propagation delay and the time length of the SA-SS in response to the T_{CP} of the SA-SS being less than the minimum SA-SS propagation delay. The network entity 1660 may include a network node. The means may be the component 198 of the network entity 1660 configured to perform the functions recited by the means.

As discussed supra, the component 199 may be configured to transmit a configuration message. The configuration message may include a first indicator of a searching time scope associated with a sensing signal. The configuration message may include a second indicator of an SA-SS gap associated with a SA-SS and the sensing signal. The component 199 may be configured to transmit the sensing signal in the sensing area. The sensing signal configuration component 199 may be configured to receive a report message. The report message may include a third indicator of a location of a target object within the sensing area calculated based on the configuration message. The component 199 may be within the network processor(s) 1612. The component 199 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. The network entity 1660 may include a variety of components configured for various functions. In one configuration, the network entity 1660 may include means for transmitting a configuration message. The configuration message may include a first indicator of a searching time scope associated with a sensing signal. The configuration message may include a second indicator of an SA-SS gap associated with a SA-SS and the sensing signal. The network entity 1660 may include means for transmitting the sensing signal in the sensing area. The network entity 1660 may include means for receiving a report message including a third indicator of a location of a target object within the sensing area calculated based on the configuration message. The network entity 1660 may include means for calculating a minimum sensing signal propagation delay and a maximum sensing signal propagation delay based on the sensing area. The searching time scope may include a third indicator of the calculated minimum sensing signal propagation delay associated with a reflection of the sensing signal off of a target object within the sensing area. The searching time scope may include a fourth indicator of the calculated maximum sensing signal propagation delay associated with the reflection of the sensing signal. The third indicator may include a first OFDM symbol index that corresponds with the minimum sensing signal propagation delay. The fourth indicator may include a second OFDM symbol index that corresponds with the maximum sensing signal propagation delay. The network entity 1660 may include means for transmitting the SA-SS in the sensing area before transmitting the sensing signal in the sensing area. The network entity 1660 may include means for transmitting a set of configuration messages including a SA-SS configuration of the SA-SS. The network entity 1660 may include means for receiving a processing capability message including a third indicator of a calculated processing latency before the transmission of the configuration message. The network entity 1660 may include means for calculating the SA-SS gap based on the calculated processing latency. The SA-SS configuration may include at least one of (1) a fourth indicator of a first direction of the SA-SS, where the first direction of the SA-SS and a second direction of the sensing signal is a same direction, (2) a fifth indicator of a bandwidth of the SA-SS, (3) a sixth indicator of a transmission power associated with the SA-SS, (4) a seventh indicator of a time domain sequence associated with the SA-SS, (5) an eighth indictor of a frequency domain sequence associated with the SA-SS, or (6) a ninth indicator of a frequency domain position associated with the SA-SS. The set of configuration messages may include at least one of an RRC message, a MAC-CE, or DCI. The network entity 1660 may include means for calculating a minimum SA-SS propagation delay and a maximum SA-SS propagation delay based on the sensing area. The SA-SS configuration may include a fourth indicator of a second searching time scope associated with the SA-SS. The searching time scope may include a fifth indicator of the calculated minimum SA-SS propagation delay associated with a reflection of the SA-SS off of a target object within the sensing area and a sixth indicator of the calculated maximum SA-SS propagation delay associated with the reflection of the SA-SS. The third indicator may include a first OFDM symbol index that corresponds with the minimum SA-SS propagation delay. The fourth indicator may include a second OFDM symbol index that corresponds with the maximum SA-SS propagation delay. The network entity 1660 may include a network node. The means may be the component 199 of the network entity 1660 configured to perform the functions recited by the means.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. When at least one processor is configured to perform a set of functions, the at least one processor, individually or in any combination, is configured to perform the set of functions. Accordingly, each processor of the at least one processor may be configured to perform a particular subset of the set of functions, where the subset is the full set, a proper subset of the set, or an empty subset of the set. If a first apparatus receives data from or transmits data to a second apparatus, the data may be received/transmitted directly between the first and second apparatuses, or indirectly between the first and second apparatuses through a set of apparatuses. A device configured to “output” data, such as a transmission, signal, or message, may transmit the data, for example with a transceiver, may send the data to a device that transmits the data, or may output the data to a component of the device. A device configured to “obtain” data, such as a transmission, signal, or message, may receive, for example with a transceiver, may obtain the data from a device that receives the data, or may obtain the data from a component of the device. Information stored in a memory includes instructions and/or data. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following aspects are illustrative only and may be combined with other aspects or teachings described herein, without limitation.

Aspect 1 is a method of wireless communication at a wireless device, comprising: receiving a configuration message comprising a first indicator of a searching time scope associated with a sensing signal or a second indicator of a sensing-associated sensing signal (SA-SS) gap associated with a SA-SS and the sensing signal; receiving a reflection of the sensing signal off of a target object within a sensing area; measuring the received reflection of the sensing signal based on at least one of the searching time scope or the SA-SS gap; and calculating a location of the target object based on the measured reflection of the sensing signal.

Aspect 2 is the method of aspect 1, further comprising outputting an indication of the calculated location of the target object.

Aspect 3 is the method of aspect 2, wherein outputting the indication of the calculated location of the target object comprises: transmitting a report message comprising a third indicator of the calculated location of the target object; or storing the indication of the calculated location of the target object.

Aspect 4 is the method of any of aspects 1 to 3, wherein the searching time scope comprises a third indicator of a minimum sensing signal propagation delay associated with the reflection of the sensing signal and the sensing area and a fourth indicator of a maximum sensing signal propagation delay associated with the reflection of the sensing signal and the sensing area.

Aspect 5 is the method of aspect 4, wherein the third indicator comprises a first orthogonal frequency division multiplexing (OFDM) symbol index that corresponds with the minimum sensing signal propagation delay and the fourth indicator comprises a second OFDM symbol index that corresponds with the maximum sensing signal propagation delay. For example, the OFDM symbol may correspond with the time occasion corresponding to the

$${τ}_{s}^{min}$$

or

$${τ}_{s}^{max}$$

value relative to the start time of receiving the OFDM symbol in which the sensing signal is transmitted.

Aspect 6 is the method of either of aspects 4 or 5, wherein receiving the reflection of the sensing signal off of the target object comprises: calculating a first point in time based on at least one of the minimum sensing signal propagation delay or the maximum sensing signal propagation delay; calculating a second point in time based on at least one of the minimum sensing signal propagation delay or the maximum sensing signal propagation delay; and monitoring for the reflection of the sensing signal between the first point in time and the second point in time. Monitoring for a reflection of a sensing signal may include using a configuration to receive a reflection of the sensing signal during a time frame, such as using a fixed window to demodulate a sensing signal, or using a set of shifting windows starting at a fixed time frame to demodulate a sensing signal.

Aspect 7 is the method of aspect 6, wherein calculating the first point in time based on at least one of the minimum sensing signal propagation delay or the maximum sensing signal propagation delay comprises at least one of: calculating the first point in time based on a T_{CP} of the sensing signal in response to the T_{CP} of the sensing signal being greater than or equal to the maximum sensing signal propagation delay; calculating the first point in time based on the T_{CP} of the sensing signal in response to the T_{CP} of the sensing signal being less than the maximum sensing signal propagation delay and greater than or equal to the minimum sensing signal propagation delay; or calculating the first point in time based on the minimum sensing signal propagation delay in response to the T_{CP} of the sensing signal being less than the minimum sensing signal propagation delay.

Aspect 8 is the method of either of aspects 6 or 7, wherein calculating the second point in time based on at least one of the minimum sensing signal propagation delay or the maximum sensing signal propagation delay comprises at least one of: calculating the second point in time based on a cyclic prefix (CP) time length (T_{CP}) of the sensing signal and a time length of the sensing signal in response to the T_{CP} of the sensing signal being greater than or equal to the maximum sensing signal propagation delay; calculating the second point in time based on the maximum sensing signal propagation delay and the time length of the sensing signal in response to the T_{CP} of the sensing signal being less than the maximum sensing signal propagation delay and greater than or equal to the minimum sensing signal propagation delay; or calculating the second point in time based on the maximum sensing signal propagation delay and the time length of the sensing signal in response to the T_{CP} of the sensing signal being less than the minimum sensing signal propagation delay.

Aspect 9 is the method of any of aspects 1 to 8, further comprising receiving a second reflection of the SA-SS off of the target object before receiving the reflection of the sensing signal off of the target object, wherein receiving the reflection of the sensing signal off of the target object comprises: calculating a termination time corresponding with when the reception of the second reflection of the SA-SS terminates; and monitoring for the reflection of the sensing signal based on the calculated termination time and the SA-SS gap.

Aspect 10 is the method of aspect 9, wherein receiving the second reflection of the SA-SS off of the target object comprises periodically monitoring for the second reflection of the SA-SS off of the target object based on a plurality of sliding windows; and selecting a sliding window from the plurality of sliding windows based on a correlation coefficient associated with the selected sliding window being greater or equal to a threshold amount, wherein the calculated termination time is based on the selected sliding window.

Aspect 11 is the method of either of aspects 9 or 10, further comprising: receiving a set of configuration messages comprising a SA-SS configuration of the SA-SS; calculating a processing latency based on the SA-SS configuration; and transmitting a processing capability message comprising a third indicator of the calculated processing latency before the reception of the configuration message, wherein the SA-SS gap is greater than or equal to the calculated processing latency.

Aspect 12 is the method of aspect 11, wherein the SA-SS configuration comprises at least one of: a fourth indicator of a first direction of the SA-SS, wherein the first direction of the SA-SS and a second direction of the sensing signal is a same direction; a fifth indicator of a bandwidth of the SA-SS; a sixth indicator of a transmission power associated with the SA-SS; a seventh indicator of a time domain sequence associated with the SA-SS; an eighth indictor of a frequency domain sequence associated with the SA-SS; or a ninth indicator of a frequency domain position associated with the SA-SS.

Aspect 13 is the method of either of aspects 11 or 12, wherein the set of configuration messages comprises at least one of a radio resource control (RRC) message, a medium access control (MAC) control element (MAC-CE), or downlink control information (DCI).

Aspect 14 is the method of any of aspects 11 to 13, wherein the SA-SS configuration comprises a fourth indicator of a second searching time scope associated with the SA-SS, wherein the second searching time scope comprises a fifth indicator of a minimum SA-SS propagation delay associated with the second reflection of the SA-SS and a sixth indicator of a maximum SA-SS propagation delay associated with the second reflection of the SA-SS.

Aspect 15 is the method of aspect 14, wherein the fifth indicator comprises a first orthogonal frequency division multiplexing (OFDM) symbol index that corresponds with the minimum SA-SS propagation delay and the sixth indicator comprises a second OFDM symbol index that corresponds with the maximum SA-SS propagation delay.

Aspect 16 is the method of either of aspects 14 or 15, wherein receiving the second reflection of the SA-SS off of the target object comprises: calculating a first point in time based on at least one of the minimum SA-SS propagation delay or the maximum SA-SS propagation delay; calculating a second point in time based on at least one of the minimum SA-SS propagation delay or the maximum SA-SS propagation delay; and monitoring for the second reflection of the SA-SS between the first point in time and the second point in time.

Aspect 17 is the method of aspect 16, wherein calculating the first point in time based on at least one of the minimum SA-SS propagation delay or the maximum SA-SS propagation delay comprises at least one of: calculating the first point in time based on a cyclic prefix (CP) time length (T_{CP}) of the SA-SS in response to the T_{CP} of the SA-SS being greater than or equal to the maximum SA-SS propagation delay; calculating the first point in time based on the T_{CP} of the SA-SS in response to the T_{CP} of the SA-SS being less than the maximum SA-SS propagation delay and greater than or equal to the minimum SA-SS propagation delay; or calculating the first point in time based on the minimum SA-SS propagation delay in response to the T_{CP} of the SA-SS being less than the minimum SA-SS propagation delay.

Aspect 18 is the method of either of aspects 16 or 17, wherein calculating the second point in time based on at least one of the minimum SA-SS propagation delay or the maximum SA-SS propagation delay comprises at least one of: calculating the second point in time based on a cyclic prefix (CP) time length (T_{CP}) of the SA-SS and a time length of the SA-SS in response to the T_{CP} of the SA-SS being greater than or equal to the maximum SA-SS propagation delay; calculating the second point in time based on the maximum SA-SS propagation delay and the time length of the SA-SS in response to the T_{CP} of the SA-SS being less than the maximum SA-SS propagation delay and greater than or equal to the minimum SA-SS propagation delay; and calculating the second point in time based on the maximum SA-SS propagation delay and the time length of the SA-SS in response to the T_{CP} of the SA-SS being less than the minimum SA-SS propagation delay.

Aspect 19 is the method of any of aspects 1 to 18, wherein the wireless device comprises a user equipment (UE) or a network node.

Aspect 20 is a method of wireless communication at a wireless device, comprising: transmitting a configuration message comprising a first indicator of a searching time scope associated with a sensing signal and a sensing area or comprising a second indicator of a sensing-associated sensing signal (SA-SS) gap associated with a SA-SS and the sensing signal; and transmitting the sensing signal in the sensing area.

Aspect 21 is the method of aspect 20, further comprising receiving a report message comprising a third indicator of a location of a target object within the sensing area calculated based on the configuration message.

Aspect 22 is the method of either of aspects 20 or 21, further comprising calculating a minimum sensing signal propagation delay and a maximum sensing signal propagation delay based on the sensing area, wherein the searching time scope comprises a third indicator of the calculated minimum sensing signal propagation delay associated with a reflection of the sensing signal off of a target object within the sensing area and a fourth indicator of the calculated maximum sensing signal propagation delay associated with the reflection of the sensing signal.

Aspect 23 is the method of aspect 22, wherein the third indicator comprises a first orthogonal frequency division multiplexing (OFDM) symbol index that corresponds with the minimum sensing signal propagation delay and the fourth indicator comprises a second OFDM symbol index that corresponds with the maximum sensing signal propagation delay.

Aspect 24 is the method of any of aspects 20 to 23, further comprising transmitting the SA-SS in the sensing area before transmitting the sensing signal in the sensing area.

Aspect 25 is the method of aspect 24, further comprising: transmitting a set of configuration messages comprising a SA-SS configuration of the SA-SS; receiving a processing capability message comprising a third indicator of a calculated processing latency before the transmission of the configuration message; and calculating the SA-SS gap based on the calculated processing latency.

Aspect 26 is the method of aspect 25, wherein the SA-SS configuration comprises at least one of: a fourth indicator of a first direction of the SA-SS, wherein the first direction of the SA-SS and a second direction of the sensing signal is a same direction; a fifth indicator of a bandwidth of the SA-SS; a sixth indicator of a transmission power associated with the SA-SS; a seventh indicator of a time domain sequence associated with the SA-SS; an eighth indictor of a frequency domain sequence associated with the SA-SS; or a ninth indicator of a frequency domain position associated with the SA-SS.

Aspect 27 is the method of either of aspects 25 or 26, wherein the set of configuration messages comprises at least one of a radio resource control (RRC) message, a medium access control (MAC) control element (MAC-CE), or downlink control information (DCI).

Aspect 28 is the method of either of aspects 25 to 27, further comprising: calculating a minimum SA-SS propagation delay and a maximum SA-SS propagation delay based on the sensing area, wherein the SA-SS configuration comprises a fourth indicator of a second searching time scope associated with the SA-SS, wherein the searching time scope comprises a fifth indicator of the calculated minimum SA-SS propagation delay associated with a reflection of the SA-SS off of a target object within the sensing area and a sixth indicator of the calculated maximum SA-SS propagation delay associated with the reflection of the SA-SS.

Aspect 29 is the method of aspect 28, wherein the third indicator comprises a first orthogonal frequency division multiplexing (OFDM) symbol index that corresponds with the minimum SA-SS propagation delay and the fourth indicator comprises a second OFDM symbol index that corresponds with the maximum SA-SS propagation delay.

Aspect 30 is the method of any of aspects 20 to 29, wherein the wireless device comprises a network node or a user equipment (UE).

Aspect 31 is an apparatus for wireless communication, including: at least one memory; and at least one processor coupled to the at least one memory and, based at least in part on information stored in the at least one memory, the at least one processor, individually or in any combination, is configured to implement any of aspects 1 to 30.

Aspect 32 is the apparatus of aspect 31, further including at least one of an antenna or a transceiver coupled to the at least one processor.

Aspect 33 is an apparatus for wireless communication including means for implementing any of aspects 1 to 30.

Aspect 34 is a computer-readable medium (e.g., a non-transitory computer-readable medium) storing computer executable code, where the code when executed by a processor causes the processor to implement any of aspects 1 to 30.

1. An apparatus for wireless communication at a wireless device, comprising:
at least one memory; and
at least one processor coupled to the at least one memory and, based at least in part on information stored in the at least one memory, the at least one processor, is configured to:
receive a configuration message comprising a first indicator of a searching time scope associated with a sensing signal or a second indicator of a sensing-associated sensing signal (SA-SS) gap associated with a SA-SS and the sensing signal;
receive a reflection of the sensing signal off of a target object within a sensing area;
measure the received reflection of the sensing signal based on at least one of the searching time scope or the SA-SS gap; and
calculate a location of the target object based on the measured reflection of the sensing signal.

2. The apparatus of claim 1, wherein the at least one processor, is further configured to:
output a third indicator of the calculated location of the target object.

3. The apparatus of claim 2, further comprising a transceiver coupled to the at least one processor, wherein, to output the third indicator of the calculated location of the target object, the at least one processor, is configured to:
transmit, via the transceiver, a report message comprising the third indicator of the calculated location of the target object; or
store the third indicator of the calculated location of the target object.

4. The apparatus of claim 1, wherein the searching time scope comprises a third indicator of a minimum sensing signal propagation delay associated with the reflection of the sensing signal and the sensing area and a fourth indicator of a maximum sensing signal propagation delay associated with the reflection of the sensing signal and the sensing area.

5. The apparatus of claim 4, wherein the third indicator comprises a first orthogonal frequency division multiplexing (OFDM) symbol index that corresponds with the minimum sensing signal propagation delay and the fourth indicator comprises a second OFDM symbol index that corresponds with the maximum sensing signal propagation delay.

6. The apparatus of claim 4, wherein, to receive the reflection of the sensing signal off of the target object, the at least one processor, is configured to:
calculate a first point in time based on at least one of the minimum sensing signal propagation delay or the maximum sensing signal propagation delay;
calculate a second point in time based on at least one of the minimum sensing signal propagation delay or the maximum sensing signal propagation delay; and
monitor for the reflection of the sensing signal between the first point in time and the second point in time.

7. The apparatus of claim 6, wherein, to calculate the first point in time based on at least one of the minimum sensing signal propagation delay or the maximum sensing signal propagation delay, the at least one processor, is configured to:
calculate the first point in time based on a cyclic prefix (CP) time length (T_{CP}) of the sensing signal in response to the T_{CP} of the sensing signal being greater than or equal to the maximum sensing signal propagation delay;
calculate the first point in time based on the T_{CP} of the sensing signal in response to the T_{CP} of the sensing signal beingless than the maximum sensing signal propagation delay and greater than or equal to the minimum sensing signal propagation delay; or
calculate the first point in time based on the minimum sensing signal propagation delay in response to the T_{CP} of the sensing signal being less than the minimum sensing signal propagation delay.

8. The apparatus of claim 6, wherein, to calculate the second point in time based on at least one of the minimum sensing signal propagation delay or the maximum sensing signal propagation delay, the at least one processor, is configured to:
calculate the second point in time based on a cyclic prefix (CP) time length (T_{CP}) of the sensing signal and a time length of the sensing signal in response to the T_{CP} of the sensing signal being greater than or equal to the maximum sensing signal propagation delay;
calculate the second point in time based on the maximum sensing signal propagation delay and the time length of the sensing signal in response to the T_{CP} of the sensing signal being less than the maximum sensing signal propagation delay and greater than or equal to the minimum sensing signal propagation delay; or
calculate the second point in time based on the maximum sensing signal propagation delay and the time length of the sensing signal in response to the T_{CP} of the sensing signal being less than the minimum sensing signal propagation delay.

9. The apparatus of claim 1, wherein the at least one processor, is further configured to:
receive a second reflection of the SA-SS off of the target object before a reception of the reflection of the sensing signal off of the target object, wherein, to receive the reflection of the sensing signal off of the target object, the at least one processor, is configured to:
calculate a termination time corresponding with when the reception of the second reflection of the SA-SS terminates; and
monitor for the reflection of the sensing signal based on the calculated termination time and the SA-SS gap.

10. The apparatus of claim 9, wherein, to receive the second reflection of the SA-SS off of the target object, the at least one processor, is configured to:
periodically monitor for the second reflection of the SA-SS off of the target object based on a plurality of sliding windows; and
select a sliding window from the plurality of sliding windows based on a correlation coefficient associated with the selected sliding window being greater or equal to a threshold amount, wherein the calculated termination time is based on the selected sliding window.

11. The apparatus of claim 9, wherein the at least one processor, is further configured to:
receive a set of configuration messages comprising a SA-SS configuration of the SA-SS;
calculate a processing latency based on the SA-SS configuration; and
transmit a processing capability message comprising a third indicator of the calculated processing latency before the reception of the configuration message, wherein the SA-SS gap is greater than or equal to the calculated processing latency.

12. The apparatus of claim 11, wherein the SA-SS configuration comprises at least one of:
a fourth indicator of a first direction of the SA-SS, wherein the first direction of the SA-SS and a second direction of the sensing signal is a same direction;
a fifth indicator of a bandwidth of the SA-SS;
a sixth indicator of a transmission power associated with the SA-SS;
a seventh indicator of a time domain sequence associated with the SA-SS;
an eighth indictor of a frequency domain sequence associated with the SA-SS; or
a ninth indicator of a frequency domain position associated with the SA-SS.

13. The apparatus of claim 11, wherein the set of configuration messages comprises at least one of a radio resource control (RRC) message, a medium access control (MAC) control element (MAC-CE), or downlink control information (DCI).

14. The apparatus of claim 11, wherein the SA-SS configuration comprises a fourth indicator of a second searching time scope associated with the SA-SS, wherein the second searching time scope comprises a fifth indicator of a minimum SA-SS propagation delay associated with the second reflection of the SA-SS and a sixth indicator of a maximum SA-SS propagation delay associated with the second reflection of the SA-SS.

15. The apparatus of claim 14, wherein the fifth indicator comprises a first orthogonal frequency division multiplexing (OFDM) symbol index that corresponds with the minimum SA-SS propagation delay and the sixth indicator comprises a second OFDM symbol index that corresponds with the maximum SA-SS propagation delay.

16. The apparatus of claim 14, wherein, to receive the second reflection of the SA-SS off of the target object, the at least one processor, is configured to:
calculate a first point in time based on at least one of the minimum SA-SS propagation delay or the maximum SA-SS propagation delay;
calculate a second point in time based on at least one of the minimum SA-SS propagation delay or the maximum SA-SS propagation delay; and
monitor for the second reflection of the SA-SS between the first point in time and the second point in time.

17. The apparatus of claim 16, wherein, to calculate the first point in time based on at least one of the minimum SA-SS propagation delay or the maximum SA-SS propagation delay, the at least one processor, is configured to:
calculate the first point in time based on a cyclic prefix (CP) time length (T_{CP}) of the SA-SS in response to the T_{CP} of the SA-SS being greater than or equal to the maximum SA-SS propagation delay;
calculate the first point in time based on the T_{CP} of the SA-SS in response to the T_{CP} of the SA-SS being less than the maximum SA-SS propagation delay and greater than or equal to the minimum SA-SS propagation delay; or
calculate the first point in time based on the minimum SA-SS propagation delay in response to the T_{CP} of the SA-SS being less than the minimum SA-SS propagation delay.

18. The apparatus of claim 16, wherein, to calculate the second point in time based on at least one of the minimum SA-SS propagation delay or the maximum SA-SS propagation delay, the at least one processor, is configured to:
calculate the second point in time based on a cyclic prefix (CP) time length (T_{CP}) of the SA-SS and a time length of the SA-SS in response to the T_{CP} of the SA-SS being greater than or equal to the maximum SA-SS propagation delay;
calculate the second point in time based on the maximum SA-SS propagation delay and the time length of the SA-SS in response to the T_{CP} of the SA-SS being less than the maximum SA-SS propagation delay and greater than or equal to the minimum SA-SS propagation delay; or
calculate the second point in time based on the maximum SA-SS propagation delay and the time length of the SA-SS in response to the T_{CP} of the SA-SS being less than the minimum SA-SS propagation delay.

19. An apparatus for wireless communication at a wireless device, comprising:
at least one memory; and
at least one processor coupled to the at least one memory and, based at least in part on information stored in the at least one memory, the at least one processor, is configured to:
transmit a configuration message comprising a first indicator of a searching time scope associated with a sensing signal and a sensing area or comprising a second indicator of a sensing-associated sensing signal (SA-SS) gap associated with a SA-SS and the sensing signal; and
transmit the sensing signal in the sensing area.

20. The apparatus of claim 19, further comprising a transceiver coupled to the at least one processor, wherein the at least one processor, is further configured to:
receive, via the transceiver, a report message comprising a third indicator of a location of a target object within the sensing area calculated based on the configuration message.

21-30. (canceled)
